(19) United States
(12) Patent Application Publication
(10) Pub. No.: US 2020/0278208 A1
(43) Pub. Date: Sep. 3, 2020

(54) INFORMATION PROCESSING APPARATUS, MOVABLE APPARATUS, INFORMATION PROCESSING METHOD, MOVABLE-APPARATUS CONTROL METHOD, AND PROGRAMS

(71) Applicant: Sony Corporation, Tokyo (JP)

(72) Inventor: Chao Wang, Tokyo (JP)

(73) Assignee: Sony Corporation, Tokyo (JP)

(21) Appl. No.: 16/649,454

(22) PCT Filed: Sep. 20, 2018
(86) PCT No.: PCT/JP2018/034753

§ 371 Date: Mar. 20, 2020

(30) Foreign Application Priority Data
Sep. 28, 2017 (JP) 2017-187481

(51) Int. Cl. G01C 21/14; G01C 21/28; G01C 21/16; G01S 19/49

(52) U.S. Cl. CPC G01C 21/14; G01S 19/49; G01C 21/165; G01C 21/28

(57) ABSTRACT

There is provided an information processing apparatus, including: a plurality of self-position calculators configured to calculate a plurality of self-positions; and a self-position integration unit configured to integrate the plurality of calculated self-positions that the plurality of self-position calculators have calculated to calculate one final self-position, the self-position integration unit converting, in consideration of sensor positions of sensors that the plurality of self-position calculators utilize, the plurality of calculated self-positions calculated by the plurality of self-position calculators and corresponding to the plurality of self-position calculators to a plurality of standard self-positions, and calculating the one final self-position by utilizing the plurality of standard self-positions being conversion results.

### CROSS REFERENCE TO RELATED APPLICATIONS

This application claims the benefit of Japanese Priority Patent Application JP 2017-187481 filed Sep. 28, 2017, the entire contents of which are incorporated herein by reference.

### TECHNICAL FIELD

The present disclosure relates to an information processing apparatus, a movable apparatus, an information processing method, a movable-apparatus control method, and programs. More specifically, the present disclosure relates to an information processing apparatus, a movable apparatus, an information processing method, a movable-apparatus control method, and programs that enable processes of moving a movable body, the processes including utilizing information items that a plurality of sensors have detected.

### BACKGROUND ART

In recent years, development of autonomous movable apparatuses such as self-driving vehicles and robots has been being actively made.

In order that the movable apparatuses such as the autonomous vehicles and the robots move along a predetermined path, a position and a posture of an own apparatus need to be accurately grasped.

There have been provided what is called self-position calculators of various types, which are devices that calculate the position and the posture of the own apparatus.

For example, a configuration that uses a GPS and an IMU (Inertial Measurement Unit) in combination with each other, and a configuration that utilizes SLAM (Simultaneous Localization and Mapping) including performing self-position calculation from information items of feature points of images captured by a camera.

At the time of calculating the self-position or both the self-position and the posture, these self-position calculators apply respective different algorithms.

However, these self-position calculators of various types have a problem that their accuracies significantly vary depending on environments.

For example, in the SLAM, processes including utilizing the images captured by the camera are executed. Thus, in environments where clear images are difficult to capture, such as night and heavy rain, a positional accuracy to be calculated degrades.

Further, in environments where data items from GPS satellites are difficult to reach, such as an environment where a large number of high-rise buildings are built, a positional accuracy to be calculated by a system that utilizes the GPS degrades.

In addition, for example, once a sensor of a self-position calculator fails, the self-position calculator depending on the sensor does not function properly any longer.

In view of such circumstances, in the past, there has been provided a configuration of a movable body as disclosed, for example, in Japanese Patent Application Laid-open No. 2014-191689, the movable body moving while checking its position by utilizing self-position calculators.

Japanese Patent Application Laid-open No. 2014-191689 discloses a highly-versatile unitized self-position detection apparatus that can be utilized together not only with the specific movable body.

### CITATION LIST

### Patent Literature

PTL 1: Japanese Patent Application Laid-open No. 2014-191689

### SUMMARY

### Technical Problem

However, even in such a unitized self-position detection apparatus, as long as a single position-detection algorithm is applied, the problem of the significant variation in accuracy depending on environments remains unsolved.

In view of the problems as described above, there is a need to provide an information processing apparatus, a movable apparatus, an information processing method, a movable-apparatus control method, and programs that enable self-position calculation with high accuracy irrespective of various environmental changes.

### Solution to Problem

According to a first embodiment of the present disclosure, there is provided an information processing apparatus, including:

a plurality of self-position calculators configured to calculate a plurality of self-positions, each self-position calculator using measurement information acquired by one or more sensors arranged in or at a movable apparatus to calculate its self-position representing the position of the respective self-position calculator; and

a self-position integration unit configured to integrate the plurality of calculated self-positions to one final self-position representing the position of the movable apparatus by

calculating a plurality of standard self-positions by converting, in consideration of sensor positions of the one or more sensors, the plurality of calculated self-positions to the plurality of standard self-positions, a standard self-position representing the position of the movable apparatus determined by converting a calculated self-position, in consideration of the one or more sensor positions of the sensors utilized by the respective self-position calculator to calculate its self-position, to said standard self-position, and calculating the one final self-position from the plurality of calculated standard self-positions.

Further, according to a second embodiment of the present disclosure, there is provided a movable apparatus, including:

an information processing apparatus as disclosed herein for calculating one final self-position representing the position of the movable apparatus;

a planning unit configured to determine an action of the movable apparatus by utilizing the calculated one final self-position; and

an operation control unit configured to control an operation of the movable apparatus on the basis of the action that the planning unit has determined.

calculating the one final self-position by utilizing the plurality of

Further, according to a third embodiment of the present disclosure, there is provided an information processing method that an information processing apparatus may carry out, the information processing method including:

respectively calculating, by a plurality of self-position calculators, a plurality of self-positions, each self-position calculator using measurement information acquired by one or more sensors arranged in or at a movable apparatus to calculate its self-position representing the position of the respective self-position calculator; and

integrating, by a self-position integration unit, the plurality of calculated self-positions to one final self-position representing the position of the movable apparatus by

calculating a plurality of standard self-positions by converting, in consideration of sensor positions of the one or more sensors, the plurality of calculated self-positions to the plurality of standard self-positions, a standard self-position representing the position of the movable apparatus determined by converting a calculated self-position, in consideration of the one or more sensor positions of the sensors utilized by the respective self-position calculator to calculate its self-position, to said standard self-position, and

calculating the one final self-position from the plurality of calculated standard self-positions.

Further, according to a fourth embodiment of the present disclosure, there is provided a movable-apparatus control method that a movable apparatus may carry, the movable-apparatus control method including:

an information processing method as disclosed herein for calculating one final self-position representing the position of the movable apparatus;

determining, by a planning unit, an action of the movable apparatus by utilizing the calculated one final self-position; and

controlling, by an operation control unit, an operation of the movable apparatus on the basis of the action that the planning unit has determined.

Further, according to a fifth embodiment of the present disclosure, there is provided a program that causes a processor or computer to carry out the steps of the information processing method disclosed herein or the movable-apparatus control method disclosed herein when said program is executed by the processor or the computer.

Further, according to a sixth embodiment of the present disclosure, there is provided a non-transitory computer-readable recording medium that stores therein a computer program product, which, when executed by a processor or computer, causes the information processing method disclosed herein or the movable-apparatus control method disclosed herein to be performed.

Note that, as examples of the programs according to the fifth embodiment and the sixth embodiment of the present disclosure, there may be mentioned programs that can be provided, for example, via a computer-readable recording medium or a computer-readable communication medium to an information processing apparatus, a computer, and a system that are capable of executing various programs and codes. By providing such programs in a computer-readable form, processes in accordance with the program are executed in the information processing apparatus, the computer, and the system.

These and other objects, features and advantages of the present disclosure will become more apparent in light of the following detailed description of best mode embodiments thereof, as shown in the accompanying drawings. Note that, the “system” herein refers to a logical collective configuration of a plurality of apparatuses, and these apparatuses having respective configurations are not necessarily provided in the same casing. Embodiments are defined in the dependent claims. It shall be understood that the disclosed movable apparatus, the disclosed methods, the disclosed programs and the disclosed computer-readable recording medium have similar and/or identical further embodiments as the claimed information processing apparatus and as defined in the dependent claims and/or disclosed herein.

### Advantageous Effects of Invention

The configuration according to the present disclosure enables acquisition of one final apparatus-position information item, i.e. the final self-position, based on a plurality of calculated self-positions that a plurality of self-position calculators configured to calculate a plurality of self-positions have calculated. From each self-position of a self-position calculator, in a first step a standard self-position is calculated, which are then used in a second step to calculate the final self-position of the movable apparatus by integrating the standard self-positions. In case one or more sensors, whose measurement information is used by one or more self-position calculators for calculating a self-position, do not work correctly or provide inaccurate measurement information, the standard self-position(s) calculated by those self-position calculators may be ignored or less weighted compared to the standard self-position(s) calculated by other self-position calculators in the calculation of the final self-position. This ensures that in many more situations than with a conventional self-position calculator a final self-position can be calculated. Further, the accuracy of the calculated final self-position can be increased.

In this context, a self-position of a self-position calculator is understood as its own position, which may be calculated based on measurement information acquired by one or more sensors arranged in or at the movable apparatus. If a self-position calculator is e.g. integrated in a respective sensor, e.g. a camera or a GPS sensor, the self-position of this self-position calculator represents the position of the respective sensor as well. The self-position may hereby be represented in a coordinate system of the respective self-position calculator or in a coordinate system of the information processing apparatus or the movable apparatus or in a global coordinate system in space, e.g. in GPS coordinates.

A standard self-position is understood as the position of the movable apparatus determined by converting a calculated self-position. Preferably, each calculated self-position is converted into a corresponding standard self-position. For instance, if three self-positions have been calculated, three standard self-positions are obtained, each representing the position of the movable apparatus, whereby each standard self-position is only computed in consideration of the one or more sensor positions of the sensors utilized by the respective self-position calculator to calculate its self-position. Hence, the computation of each standard self-position does only use part of all the available measurement information from different sensors.

A final self-position is understood as the position of the movable apparatus, preferably in a coordinate system of the movable apparatus or in a global coordinate system in space, e.g. in GPS coordinates. The final self-position does hence take into account all the available measurement information from the different sensor.

According to an embodiment, the self-position integration unit is configured to determine, on the basis of environment information items, a processing pattern for calculating the one final self-position from the plurality of calculated standard self-positions. Such environment information may e.g. be information about brightness, field of vision, operating conditions of the sensors, etc., i.e., information which may have an impact on the accuracy and reliability of one or more sensors and the measurement information acquired by the respective sensors. The use of such environment information may thus improve the accuracy and reliability of the calculated final self-position.

For instance, as provided in an embodiment, the self-position integration unit may be configured to take the environment information into account by weighting or discarding one or more of the calculated standard self-positions in the calculation of the one final self-position. Thus, the measurement information of less reliable sensors can be weighted by a smaller weight than the measurement information of other more reliable sensors.

In a practical embodiment the environment information items include at least any of an information item of an external environment of the movable apparatus that moves along a movement path to be determined by application of the one final self-position, information items of failures of the sensors, and an information item of a utilization condition of a resource. It may depend on the available means for obtaining environment information items, which environment information items can actually be used in a practical scenario.

For determining the final self-position different options exist. According to one embodiment the self-position integration unit may further be configured to select, on the basis of environment information items, one standard self-position from among the plurality of calculated standard self-positions, and to determine the one selected standard self-position as the one final self-position. This embodiment is computationally simple since it merely requires a selection process.

According to another embodiment the self-position integration unit may be configured to calculate, on the basis of environment information items, one fused standard self-position by fusing the plurality of calculated standard self-positions, and determine the calculated one fused standard self-position as the one final self-position. Fusing may generally be understood as any kind of combining the plurality of calculated standard self-positions. In a preferred embodiment the one fused standard self-position may be computed by fusing the plurality of calculated standard self-positions by probability integration by Kalman filtering or by proportion integration. This way of fusing provides accurate results.

In another embodiment the self-position integration unit is configured to determine one selected standard self-position by i) selecting, on the basis of environment information items, one standard self-position from among the plurality of calculated standard self-positions, ii) calculate, on the basis of the environment information items, one fused standard self-position by fusing the plurality of calculated standard self-positions, iii) switch, on the basis of the environment information items, the one selected standard self-position and the one fused standard self-position to each other, and iv) determine, as the one final self-position, one of the one selected standard self-position and the one fused standard self-position.

The information processing apparatus may further comprise a storage unit configured to store a relative-position tree that records a plurality of differently-defined coordinate origins and relative positions of the plurality of differently-defined coordinate origins and object positions. The self-position integration unit will then calculate the one final self-position as an information item of updating the relative-position tree. Hereby, the relative-position tree may include a plurality of self-position-calculator-corresponding sensor nodes having information items of the sensor positions corresponding to the plurality of self-position calculators that move along with movement of the movable apparatus, and a plurality of self-position-calculator origin nodes each having an information item of a position that does not move along with the movement of the movable apparatus, and relative positions of the plurality of self-position-calculator-corresponding sensor nodes and the plurality of self-position-calculator origin nodes as link data items. This information enables the conversion (e.g. coordinate transformation) of information collected by and/or computed from the measurement information of the sensors in order to obtain the final self-position. The information in the storage unit may be collected in advance and/or may be known from the design of the movable apparatus and the arrangement of the sensor in/at the movable apparatus.

The relative-position tree may further include one apparatus-origin node indicating an apparatus origin position of the movable apparatus, wherein the plurality of self-position-calculator-corresponding sensor nodes corresponding respectively to the plurality of self-position calculators are connected to the one apparatus origin node with links that indicate relative positions of the plurality of self-position-calculator-corresponding sensor nodes with respect to the one apparatus origin node. The apparatus-origin node may e.g. be the center of the movable apparatus, and the links may be known from the placement of the sensors in/at the movable apparatus.

The self-position integration unit may further be configured to calculate the one final self-position as an information item of updating the apparatus origin position contained in the relative-position tree.

In another embodiment the self-position integration unit may be configured to calculate a standard self-position by converting a calculated self-position into a standard self-position by use of link data that indicate the relative position of the self-position calculator with respect to an apparatus origin and/or of link data that indicate the relative position of the self-position calculator with respect to a self-position-calculator origin. The link data may be known or acquired in advance. The use of such link data provides a simple method to obtain the standard self-position(s). Note that, the advantages disclosed herein are merely examples and not limited thereto, and other advantages may be additionally obtained.

### BRIEF DESCRIPTION OF DRAWINGS

FIG. 1 is an explanatory diagram showing self-position calculators and coordinate systems to be utilized in a procedure of calculating a self-position of a movable apparatus.

FIG. 2 is an explanatory view showing an example of how the plurality of self-position calculators are attached to the movable apparatus.

FIG. 3 is an explanatory diagram showing an example of a relative-position tree.

FIG. 4 is a diagram showing a configuration example of an apparatus that executes processes of utilizing the relative-position tree.

FIG. 5 is a diagram showing another configuration example of the apparatus that executes the processes of utilizing the relative-position tree.

FIG. 6 is an explanatory diagram showing a problem in a case where the self-position calculators to which a plurality of different algorithms are applied are utilized in a configuration to which the relative-position tree is applied.

FIG. 7 is a diagram showing a configuration example of the relative-position tree to be utilized in the procedure according to an embodiment of the present disclosure.

FIG. 8 is an explanatory view showing functions of nodes of origins of the self-position calculators, which are added as most-downstream nodes.

FIG. 9 is an explanatory diagram showing a specific example of a relative-position information item corresponding to a link.

FIG. 10 is an explanatory diagram showing a specific example of processes of updating the relative-position tree.

FIG. 11 is an explanatory diagram showing a general example of the processes of updating the relative-position tree, to which the procedure according to the embodiment of the present disclosure is applied.

FIG. 12 is an explanatory diagram showing processes of updating data items of two nodes of a self-position origin and an apparatus origin in the relative-position tree.

FIG. 13 is an explanatory diagram showing processes that a self-position integration unit executes.

FIG. 14 is an explanatory view showing an example of calculating a standard self-position P corresponding to a self-position calculator P.

FIG. 15 is an explanatory view showing another example of calculating the standard self-position P corresponding to the self-position calculator P.

FIG. 16 is an explanatory view showing still another example of calculating the standard self-position P corresponding to the self-position calculator P.

FIG. 17 is an explanatory table showing processes of determining a standard self-position to be applied to an update of the tree, the processes including selecting one standard self-position from among a plurality of standard self-positions corresponding to a plurality of self-position calculators.

FIG. 18 is an explanatory table showing processes of generating the one standard self-position from the plurality of standard self-positions corresponding to the plurality of self-position calculators.

FIG. 19 is an explanatory flowchart showing a sequence of the processes that the movable apparatus executes.

FIG. 20 is another explanatory flowchart showing the sequence of the processes that the movable apparatus executes.

FIG. 21 is an explanatory diagram showing a configuration example of a vehicle control system as an example of a movable-object control system that can be installed in the movable apparatus.

FIG. 22 is an explanatory diagram showing a configuration example of hardware of an information processing apparatus.

### DESCRIPTION OF EMBODIMENTS

Now, details of an information processing apparatus, a movable apparatus, an information processing method, a movable-apparatus control method, and programs according to an embodiment of the present disclosure are described with reference to the drawings. Note that, the description is made in the following order.

1. Self-Position Calculators and Coordinate Systems to Be Utilized in Self-Position Calculation Procedure

2. Relative-Position Tree

3. Configuration That Enables Self-Position Calculation with High Accuracy in Various Environments by Utilizing Plurality of Different Self-Position Calculators

4. Sequence of Processes That Movable Apparatus Executes

5. Configuration Example of Movable Apparatus

6. Configuration Example of Information Processing Apparatus

7. Summary of Configuration According to Embodiment of Present Disclosure

(1. Self-Position Calculators and Coordinate Systems to be Utilized in Self-Position Calculation Procedure)

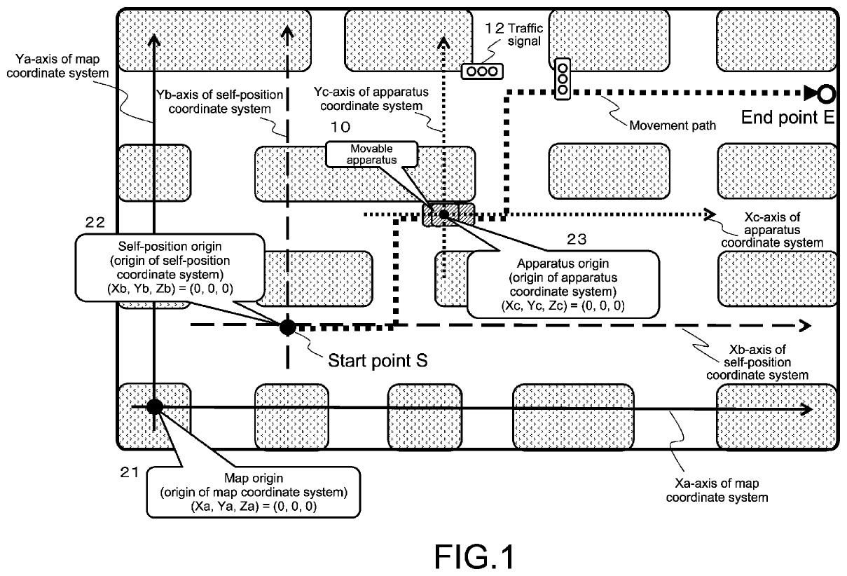

First, with reference to FIG. 1 and subsequent figures, self-position calculators and coordinate systems to be utilized in a procedure according to the embodiment of the present disclosure, that is, a procedure of calculating a self-position of a movable apparatus is described.

FIG. 1 shows a map. In a central portion of the map, a movable apparatus 10 that moves along a preset movement path is indicated.

The movable apparatus 10 moves from a start point S to an end point E shown in FIG. 1 along the preset movement path.

Note that, although the movable apparatus 10 exemplified below in this embodiment is an automobile (vehicle), the procedure according to the embodiment of the present disclosure can be utilized in various movable apparatuses other than the automobile.

As examples of the various other movable apparatuses to which the procedure according to the embodiment of the present disclosure is applicable, there may be mentioned robots (walking type and wheel-driving type), flying objects such as a drone, and ships and submarines that move on-water or underwater.

The movable apparatus 10 includes a plurality of self-position calculators having different configurations. As specific examples, there may be mentioned self-position calculators configured as follows.

(1) Self-position calculator that uses signals received from a GPS (Global Positioning System) or a GNSS (Global Navigation Satellite System) and an IMU (Inertial Measurement Unit) in combination with each other

(2) Self-position calculator that utilizes SLAM (Simultaneous Localization and Mapping) including performing self-position estimation on the basis of images captured by a camera

(3) Self-position calculator to which odometry (wheel odometry) of performing self-position estimation from a wheel r.p.m and a steering angle is applied

(4) Self-position calculator that uses NDT (Normal Distributions Transform) for estimating a self-position by matching of a high-precision three-dimensional map and observation results from sonar or LiDAR (Light Detection and Ranging, Laser Imaging Detection and Ranging) for acquiring information items of surroundings with use of pulsed laser beams

The self-position calculators (1) to (4) are devices that estimate a self-position on the basis of respective different algorithms.

Note that, the self-position calculators (1) to (4) are typical examples of the self-position calculators, and in the procedure according to the embodiment of the present disclosure, not only these devices (1) to (4) but also various other self-position calculators can be utilized.

For example, the movable apparatus 10 shown in FIG. 1 includes at least two or more different self-position calculators of these self-position calculators (1) to (4) or other self-position calculators.

Note that, calculation information items by the self-position calculators are either one of position information items of the movable apparatus 10, and combinations of the position information items and posture information items of the movable apparatus 10.

Further, as, for example, in the SLAM, in a case of performing the self-position estimation on the basis of images captured by a camera, not only general visible-light cameras, but also cameras such as a ToF (Time Of Flight) camera, a stereo camera, a monocular camera, and an infrared camera can be utilized.

In the self-position calculation procedure to which the procedure according to the embodiment of the present disclosure is applied, processes of utilizing a plurality of coordinate systems and a relative-position tree are executed.

On the map shown in FIG. 1, the following three coordinate systems are indicated.

(1) Map coordinate system
(2) Self-position coordinate system
(3) Apparatus coordinate system Now, these coordinate systems are described.

(1) Map Coordinate System

The map coordinate system is a coordinate system in which a point set on the map is defined as an origin (map origin).

A map origin 21 shown in FIG. 1 corresponds to an origin (Xa, Ya, Za)=(0, 0, 0) of the map coordinate system.

An axis extending rightward from the map origin 21 corresponds to an X-axis of the map coordinate system, which is represented as an Xa-axis.

An axis extending upward from the map origin 21 corresponds to a Y-axis of the map coordinate system, which is represented as a Ya-axis.

Note that, in FIG. 1, not only the X-axis and the Y-axis, but also a Z-axis (not shown) set upward and perpendicular to the drawing sheet of FIG. 1 exists.

In this way, in the map coordinate system, a stationary point set on the map is defined as the map origin.

(2) Self-position coordinate system

The self-position coordinate system is a coordinate system in which a point on the movement path of the movable apparatus 10, for example, the start point S shown in FIG. 1 is defined as an origin (self-position origin).

A self-position origin 22 shown in FIG. 1 corresponds to an origin (Xb, Yb, Zb)=(0, 0, 0) of the self-position coordinate system.

An axis extending rightward from the self-position origin 22 corresponds to an X-axis of the self-position coordinate system, which is represented as an Xb-axis.

An axis extending upward from the self-position origin 22 corresponds to a Y-axis of the self-position coordinate system, which is represented as a Yb-axis.

Note that, in FIG. 1, not only the X-axis and the Y-axis, but also a Z-axis (not shown) set upward and perpendicular to the drawing sheet of FIG. 1 exists.

In this way, in the self-position coordinate system, a point on the movement path of the movable apparatus 10, for example, the start point S shown in FIG. 1 is defined as an origin (self-position origin).

(3) Apparatus Coordinate System

The apparatus coordinate system is a coordinate system in which a point inside the movable apparatus 10, for example, an apparatus origin 23 indicated in the movable apparatus 10 shown in FIG. 1 is defined as an origin.

The apparatus origin 23 shown in FIG. 1 corresponds to an origin (Xc, Yc, Zc)=(0, 0, 0) of the self-position coordinate system.

An axis extending rightward from the apparatus origin 23 corresponds to an X-axis of the apparatus coordinate system, which is represented as an Xc-axis.

An axis extending upward from the apparatus origin 23 corresponds to a Y-axis of the apparatus coordinate system, which is represented as a Yc-axis.

Note that, in FIG. 1, not only the X-axis and the Y-axis, but also a Z-axis (not shown) set upward and perpendicular to the drawing sheet of FIG. 1 exists.

In this way, in the apparatus coordinate system, a point inside the movable apparatus 10 is defined as an origin (apparatus origin).

In the self-position calculation procedure according to the embodiment of the present disclosure, for example, processes of utilizing the coordinate systems of these three types are executed.

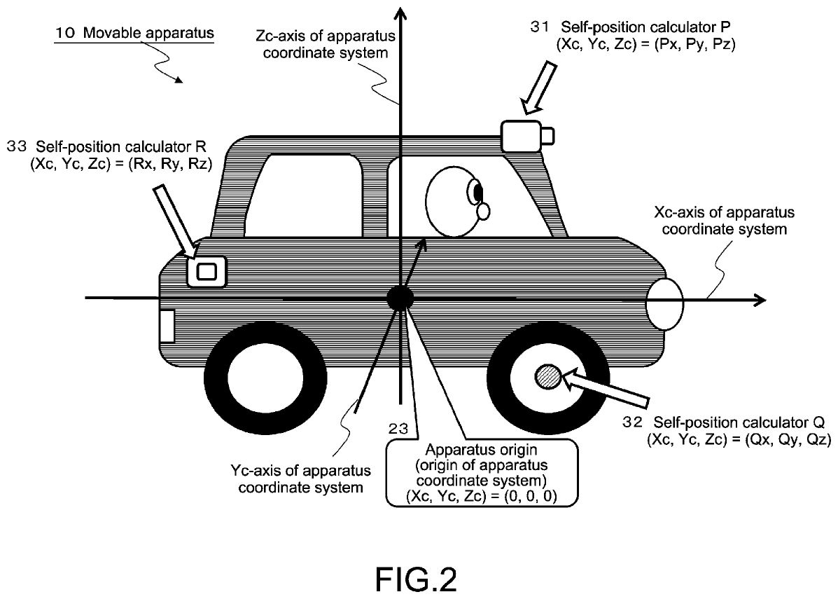

Next, with reference to FIG. 2, an example of how the plurality of self-position calculators are attached to the movable apparatus 10 is described.

As shown in FIG. 2, the plurality of self-position calculators are attached to the movable apparatus 10.

In the example shown in FIG. 2, the following three self-position calculators are attached.

Self-position calculator P31

Self-position calculator Q32

Self-position calculator R33

These three self-position calculators are attached to different positions in the movable apparatus 10.

The self-position calculator P31 is, for example, the self-position calculator that utilizes the SLAM (Simultaneous Localization and Mapping) including performing the self-position estimation on the basis of images captured by a camera.

The self-position calculator Q32 is, for example, the self-position calculator to which the odometry (wheel odometry) of performing the self-position estimation from a wheel r.p.m and a steering angle is applied.

The self-position calculator R33 is, for example, the self-position calculator that uses the signals received from the GPS (Global Positioning System) or the GNSS (Global Navigation Satellite System) and the IMU (Inertial Measurement Unit) in combination with each other.

These three self-position calculators respectively calculate positions to which their sensors are attached.

However, the positions to which these three self-position calculators are attached are different from each other with respect to the movable apparatus 10.

The attachment positions of the self-position calculators in the apparatus coordinate system (Xc, Yc, Zc) are represented as follows.

The attachment position of the self-position calculator P31 is represented by (Xc, Yc, Zc)=(Px, Py, Pz).

The attachment position of the self-position calculator Q32 is represented by (Xc, Yc, Zc)=(Qx, Qy, Qz).

The attachment position of the self-position calculator R33 is represented by (Xc, Yc, Zc)=(Rx, Ry, Rz).

Therefore, position information items that these three self-position calculators calculate differ from each other in accordance with the attachment positions of the calculators. In addition, the self-position calculation algorithms that the self-position calculators respectively execute are also different from each other, and hence differences based on the differences of the calculation algorithms also occur.

Thus, in order to calculate one final position-information item of the movable apparatus 10 by utilizing the position information items that the plurality of different self-position calculators calculate, processes of integrating the position information items that the plurality of different self-position calculators calculate need to be executed.

(2. Relative-Position Tree)

In the procedure according to the embodiment of the present disclosure, in order to execute the processes of integrating the position information items that the plurality of different self-position calculators calculate, a relative-position tree that defines, for example, relationships between the plurality of different coordinate systems, and positional relationships between the coordinate origins and an object is used.

Now, this relative-position tree is described.

In order to calculate the position of the movable apparatus 10 described above with reference to FIG. 1, a plurality of relative positional relationships need to be managed. For example, it is necessary to grasp relative positional relationships between the various different coordinate systems, and relative positional relationships between the coordinate origins and the object. More specifically, it is necessary to grasp the following relationships.

Relative position of the map origin 21 and the apparatus origin 23 described with reference to FIG. 1

Relative positions of the apparatus origin 23 and the self-position calculators described with reference to FIG. 2, or the sensors utilized thereby

Relative positions of the movable apparatus 10 and the sensors, and, for example, a person who can be an obstacle to the movable apparatus 10, a sign, or a traffic signal

The relative positional relationships each refer to a relationship of a relative position (or positions and postures) of, for example, two coordinate systems or two objects.

Note that, in the following, the relative positional relationships are referred to also as relative positions.

As an example of the relative positional relationships or the relative positions, there may be mentioned information items of correspondences between an origin position in one of the coordinate systems and a three-dimensional position and a posture of an actual object.

Note that, a relative positional relationship of the object with respect to the origin of one of the coordinate systems, and a reverse relationship thereof, that is, a relative position of the origin with respect to the object are interchangeable with each other. In other words, acquisition of certain one relative position and acquisition of a reverse relationship of the relative position are synonymous with each other.

By acquiring combinations of a plurality of different relative positions, on the basis of the combinations of the relative positions, a new relative position can be acquired.

For example,

when relative positions of the following two types, that is,

(a) Relative position of the apparatus origin and the self-position calculator (sensor), and

(b) Relative position of the self-position calculator (sensor) and a person can be acquired,

(c) Relative position of the apparatus origin and the person can be calculated.

Further, it is also possible to acquire the same relative position on the basis of the combinations of the plurality of different relative positions.

For example, on the basis of relative positions of the following two different types, that is,

(Pa) Relative position of the map origin and the self-position calculator P (camera sensor), and

(Pb) Relative position of the apparatus origin and the self-position calculator P (camera sensor),

(Pc) Relative position of the map origin and the apparatus origin can be calculated.

Further, on the basis of relative positions of the following two different types, that is,

(Ra) Relative position of the map origin and the self-position calculator R (GPS antenna), and

(Rb) Relative position of the apparatus origin and the self-position calculator R (GPS antenna),

(Rc) Relative position of the map origin and the apparatus origin can be calculated.

Note that, although two of the above-mentioned relative positions, that is,

“(Pc) Relative position of the map origin and the apparatus origin,” which is calculated with use of the self-position calculator P (camera sensor), and

“(Rc) Relative position of the map origin and the apparatus origin,” which is calculated with use of the self-position calculator R (GPS antenna),

should be the same as each other, values of these relative positions may differ from each other due, for example, to the difference in self-position calculation algorithm or to the difference in sensor attachment position of the self-position calculators.

When different relative positions are calculated depending on which of the self-position calculators to use in this way, there arises a problem that different self-positions of the movable apparatus 10 are calculated depending on which of the self-position calculators to utilize.

In order to solve such problems, the “relative-position tree” is utilized.

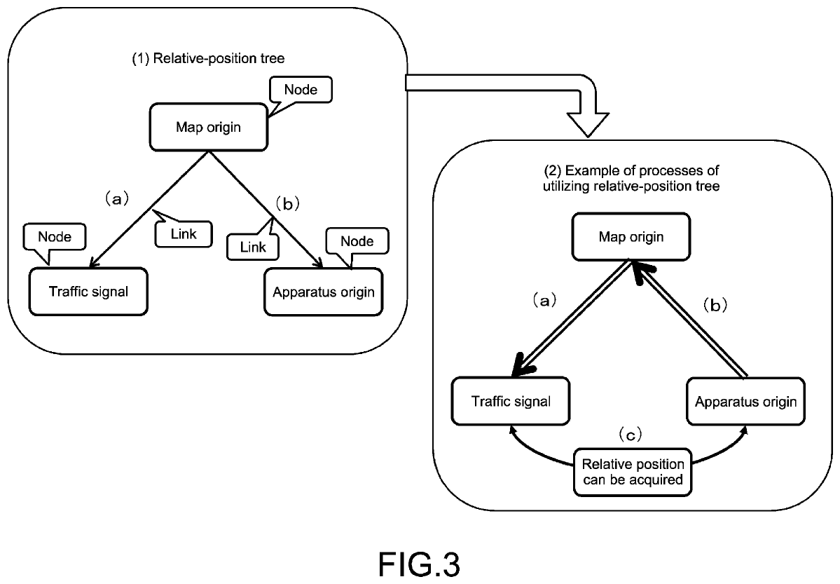

With reference to FIG. 3, an example of the relative-position tree is described.

As shown in (1) of FIG. 3, the relative-position tree has a tree structure in which nodes are connected with links.

The relative-position tree is stored, for example, in a storage unit in a movable apparatus that moves autonomously.

The connections of the nodes with the links indicate that an information item of a relative position of two of the nodes, which are connected with the link, are maintained as a record information item. In other words, for example, a relative position of a child node on a downstream side of the tree with respect to a parent node on an upstream side of the tree, the nodes being connected to each other with the link, is stored as the record information item in the storage unit.

In the relative-position tree shown in (1) of FIG. 3, the following two relative positions are set as a tree structure.

(a) Relative position of the map origin and the traffic signal

(b) Relative position of the map origin and the apparatus origin

For example, relative positions of the map origin 21, a traffic signal 12, and the apparatus origin 23 shown in FIG. 1 are set as this relative-position tree.

A link (a) of the relative-position tree shown in (1) of FIG. 3 indicates that an information item of the relative position of the map origin 21 and the traffic signal 12 is contained as a record information item of this relative-position tree, that is, stored in the storage unit storing the relative-position tree. In still other words, the link (a) indicates that various modules such as a path determination module of the movable apparatus can acquire the relative-position information item from the storage unit at various timings.

Note that, specifically, this relative-position information item of (a) is constituted, for example, by a data item of correspondences of an information item of three-dimensional coordinates of a position of the map origin 21, an information item of three-dimensional coordinates of a position of the traffic signal 12, and a posture information item of the traffic signal 12 (triaxial posture-information item).

Note that, the information item of the three-dimensional coordinates of the position of the map origin 21, and the information item of the three-dimensional coordinates of the position of the traffic signal 12 are information items in the same coordinate system, for example, in the map coordinate system.

Further, the link (b) indicates that an information item of the relative position of the map origin and the apparatus origin is contained as the record information item, and can be acquired.

This relative-position information item of this link (b) is constituted, for example, by a data item of a correspondence of the information item of three-dimensional coordinates of the position of the map origin 21, and an information item of three-dimensional coordinates of a position of the apparatus origin 23.

Note that, the information item of the three-dimensional coordinates of the position of the map origin 21, and the information item of the three-dimensional coordinates of the position of the apparatus origin 23 are information items in the same coordinate system, for example, in the map coordinate system.

(2) of FIG. 3 is a diagram showing an example of the processes of using the relative-position tree shown in (1) of FIG. 3.

By utilizing the relative-position tree in which the following two relative positions, that is,

(a) Relative position of the map origin and the traffic signal, and

(b) Relative position of the map origin and the apparatus origin are defined,

(c) Relative position of the apparatus origin and the traffic signal can be calculated.

Note that, the structure of the relative-position tree is employed, for example, in a ROS (Robot Operating System) being an open-source robotics framework.

The stored information item of the relative-position tree, that is, for example, a relative position of an origin and an object in a certain coordinate system successively changes, and hence needs to be successively updated. For example, along with movement of the movable apparatus 10, the relative positions of the self-position calculators (sensors) attached to the movable apparatus 10 and the map origin successively change, and hence need to be successively updated.

When the processes of utilizing the relative-position tree, specifically, the processes such as those in the procedure of calculating a self-position by utilizing the relative-position tree are executed,

a module that executes processes of updating the relative-position tree, that is, a relative-position-tree update module is needed.

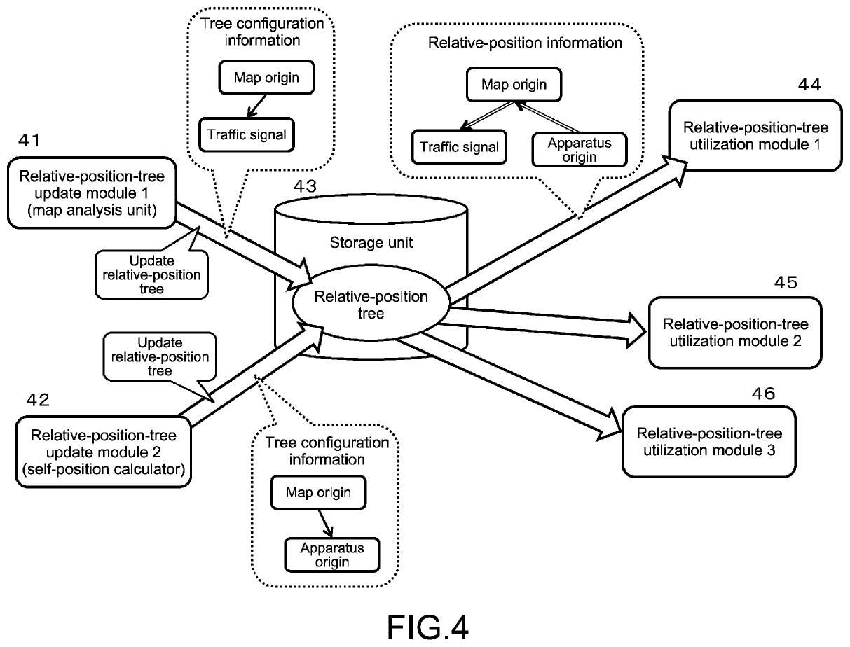

FIG. 4 is a diagram showing a configuration example of an apparatus that executes the processes of utilizing the relative-position tree.

The apparatus shown in FIG. 4 includes the following components.

Relative-position-tree update modules 41 and 42 that execute the processes of updating the relative-position tree

Storage Unit 43 that Stores the Relative-Position Tree

Relative-position-tree utilization modules 44 to 46 that acquire various relative-position information items by utilizing the relative-position tree stored in the storage unit 43

The relative-position-tree update modules 41 and 42 are each constituted, for example, by a map analysis unit that analyzes an information item of the map, and the self-position calculator.

The relative-position-tree update module 1 (map analysis unit) 41 acquires the relative position of the map origin and the traffic signal on the basis of information items to be acquired from the map, such as an information item of the position of the traffic signal, and executes the processes of updating the relative-position tree stored in the storage unit 43.

Further, the relative-position-tree update module 2 (self-position calculator) 42 acquires the relative position of the map origin and the apparatus origin on the basis of, for example, information items of the self-position that the self-position calculator calculates, and executes the processes of updating the relative-position tree stored in the storage unit 43.

By the tree update processes that these relative-position-tree update modules execute, the relative-position tree stored in the storage unit 43 is constantly updated to latest versions.

The relative-position tree stored in the storage unit 43 is read out by the various relative-position-tree utilization modules 44 to 46. With this, for example, the relative positions of the origins of the coordinate systems and the objects, and information items of the relative positions of the movable apparatus and the obstacles are acquired and utilized. The relative-position information items are utilized, for example, by the processes described above with reference to (2) of FIG. 3.

The relative-position-tree utilization modules 44 to 46 are, for example, a route planning unit that determines a travel path of the movable apparatus 10, an action planning unit, an automatic-operation planning unit, and a driving control unit. As a more specific example, there may be mentioned a module that executes processes of determining a safe travel path out of the obstacle, the relative position of which is to be calculated.

As in the configuration described with reference to FIG. 4, the self-position calculators are utilized as the relative-position-tree update modules.

As described above, the self-position calculators of the various types may be employed. As examples, there may be mentioned the following devices.

(1) Self-position calculator that uses the GPS or the GNSS and the IMU in combination with each other

(2) Self-position calculator that utilizes the SLAM

(3) Self-position calculator to which the odometry (wheel odometry) is applied

(4) Self-position calculator that uses the LiDAR or the sonar

However, these devices have a problem that their accuracies significantly vary depending on environments.

For example, in the SLAM, processes on the basis of images captured by a camera are executed. Thus, in environments where clear images of surroundings are difficult to capture, such as night and heavy rain, a positional accuracy to be calculated degrades.

Further, in environments where data items from GPS satellites are difficult to reach, such as an environment where a large number of high-rise buildings are built, a positional accuracy to be calculated by a system that utilizes the GPS degrades.

In this way, the self-position calculators vary in performance and availability depending on variation or difference in environment. There is no self-position calculator capable of calculating position information items with high accuracy regardless of environment.

Further, once a sensor fails, a self-position calculator depending on the sensor does not function properly any longer.

When the plurality of different self-position calculators are attached to a single apparatus such as the movable apparatus 10, a configuration capable of acquiring position information items with high accuracy in various environments, that is, a highly robust configuration can be provided.

However, when the processes of updating the relative-position tree stored in the storage unit are executed with use of the plurality of different self-position calculators, the plurality of different self-position calculators may respectively output different conflicting relative-position information items as information items of a relative position of the same pair of nodes in the relative-position tree. As a result, the processes of updating the relative-position tree may not be properly executed.

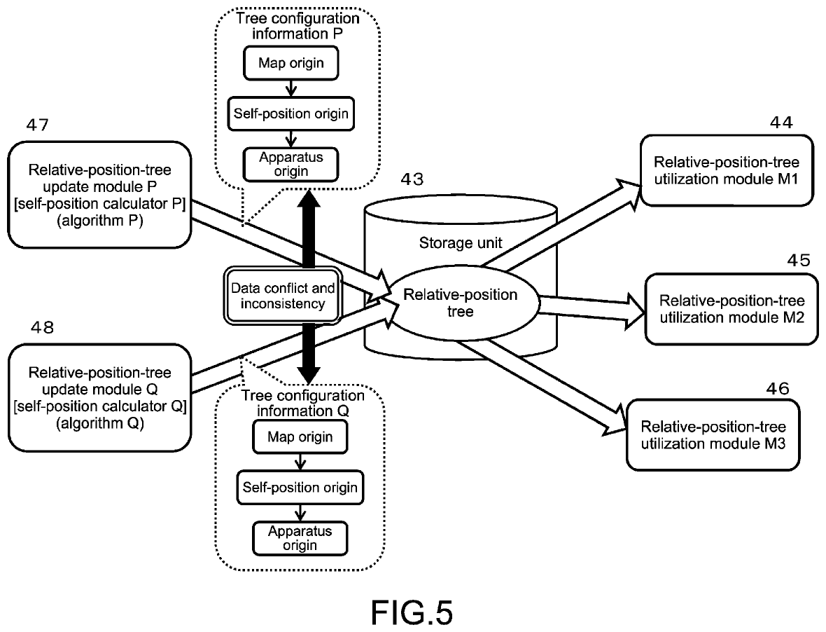

With reference to FIG. 5, this problem is described.

FIG. 5 is a diagram showing another configuration example of the apparatus that executes the processes of utilizing the relative-position tree as in FIG. 4.

The apparatus shown in FIG. 5 includes the following components similar to those in FIG. 4.

Relative-position-tree update modules 47 and 48 that execute the processes of updating the relative-position tree

Storage Unit 43 that Stores the Relative-Position Tree

Relative-position-tree utilization modules 44 to 46 that acquire various relative-position information items by utilizing the relative-position tree stored in the storage unit 43

In the configuration shown in FIG. 5, the relative-position-tree update modules 47 and 48 are constituted respectively by two self-position calculators P and Q that perform self-position calculations on the basis of different algorithms P and Q.

Other configuration features are the same as those described with reference to FIG. 4.

In the configuration shown in FIG. 5, the relative-position-tree update module P (self-position calculator P) 47 is a self-position calculator that performs the self-position calculation utilizing the algorithm P.

On the basis of an information item of the calculated position, the relative-position-tree update module P (self-position calculator P) 47 acquires the relative positions of the map origin, the self-position origin, and the apparatus origin, and generates an update information item for executing the processes of updating the relative-position tree stored in the storage unit 43. The update information item to be generated is

Tree-configuration information item P=Relative positions of the map origin, the self-position origin, and the apparatus origin.

Meanwhile, the relative-position-tree update module Q (self-position calculator Q) 48 is a self-position calculator that performs the self-position calculation utilizing the algorithm Q. On the basis of an information item of the calculated position, the relative-position-tree update module Q (self-position calculator Q) 48 acquires the relative positions of the map origin, the self-position origin, and the apparatus origin, and generates an update information item for executing the processes of updating the relative-position tree stored in the storage unit 43.

The update information item to be generated is

Tree-configuration information item Q=Relative positions of the map origin, the self-position origin, and the apparatus origin.

Note that, with regard to the update information item that the relative-position-tree update module P (self-position calculator P) 47 generates, that is,

Tree-configuration information item P=Relative positions of the map origin, the self-position origin, and the apparatus origin, and

the update information item that the relative-position-tree update module Q (self-position calculator Q) 48 generates, that is,

Tree-configuration information item Q=Relative positions of the map origin, the self-position origin, and the apparatus origin,

these two update information items are each an information item of relative positions of the same pairs of nodes in the relative-position tree.

In other words, the two relative-position-tree update modules generate the same conflicting update information items.

When these two update information items are consistent with each other, and are constituted by the same data items, there is no particular problem in updating the relative-position tree stored in the storage unit 43 with these common data items.

However, the two relative-position-tree update module P (self-position calculator P) 47 and relative-position-tree update module Q (self-position calculator Q) 48 are modules that execute the position-information calculation processes based on the different algorithms, respectively. In addition, the position calculation sensors are attached to different positions.

Thus, the information items that these two modules calculate may be inconsistent with each other, that is, may be different from each other.

In such a case, when the relative-position tree stored in the storage unit 43 is updated with the information item that either one of the self-position calculators calculates, there occurs an inconsistency with the position information item that another one of the self-position calculators calculates.

When such an inconsistency occurs, also in the processes that the relative-position-tree utilization modules execute by utilizing the relative positions, there may occur errors between these relative positions and actual relative positions. As a result, the self-position of the movable apparatus may not be accurately recognized.

In this way, when the plurality of different self-position calculators are utilized as the relative-position-tree update modules, there arises a problem that values calculated respectively by the calculators are different from each other.

Thus, there is a problem that the configuration of utilizing the self-position calculators to which the plurality of different algorithms are applied is difficult to apply to the configuration to which the relative-position tree is applied.

Note that, not only in the configuration utilizing the plurality of self-position calculators to which the different algorithms are applied, but also in a case of utilizing a plurality of self-position calculators to which the same algorithm is applied, there arises a problem that values calculated respectively by the calculators are different from each other due, for example, to the difference in attachment position between the self-position calculators, the difference in measurement accuracy between the self-position calculators, and to measurement errors.

(3. Configuration that Enables Self-Position Calculation with High Accuracy in Various Environments by Utilizing Plurality of Different Self-Position Calculators)

Next, a configuration of solving the above-described problem, that is, the configuration to which the relative-position tree is applied and which enables self-position calculation with high accuracy in various environments by utilizing the plurality of different self-position calculators is described.

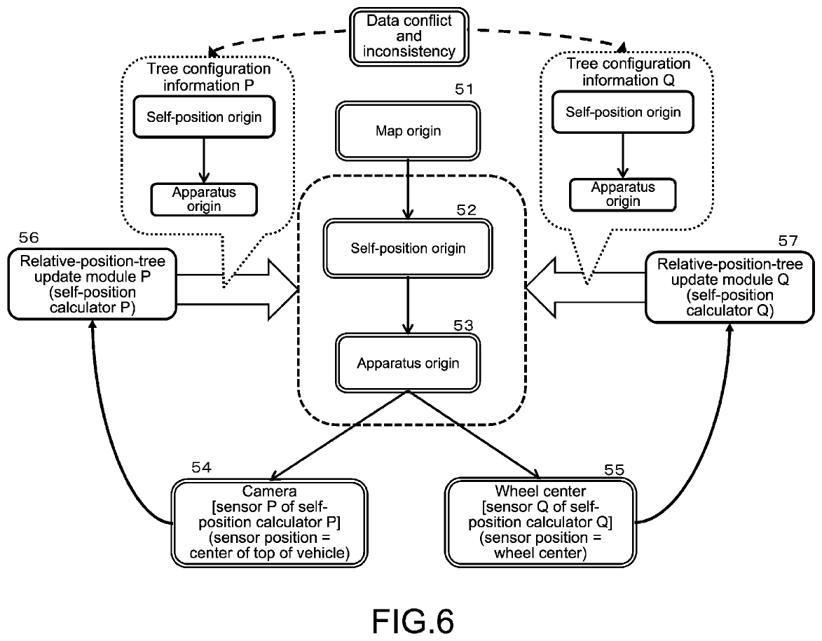

First, with reference to FIG. 6, a problem in the case where the plurality of self-position calculators are utilized in the configuration to which the relative-position tree is applied is summarized.

Note that, the procedure according to the embodiment of the present disclosure is not limited to the configuration described below in this embodiment, that is, the configuration of utilizing the self-position calculators to which the plurality of different algorithms are applied, and is applicable also to the configuration of utilizing the plurality of self-position calculators to which the same algorithm is applied.

A tree shown at a center of FIG. 6, that is, a tree configuration constituted by five nodes of a map origin 51, a self-position origin 52, an apparatus origin 53, a camera 54, and a wheel center 55 is defined as the relative-position tree stored in the storage unit in the movable apparatus.

When connection links are set between the nodes in this relative-position tree, information items of relative positions of the nodes are stored in the storage unit.

The relative-position information items need to be successively updated along, for example, with the movement of the movable apparatus.

The configuration shown in FIG. 6 includes the following two relative-position-tree update modules.

Relative-position-tree update module P (self-position calculator P) 56

Relative-position-tree update module Q (self-position calculator Q) 57

The relative-position-tree update module P (self-position calculator P) 56 is a relative-position calculator to which, for example, the SLAM is applied, whereby a self-position is calculated on the basis of images captured by the camera 54 set as a most-downstream node in the relative-position tree.

The relative-position-tree update module P (self-position calculator P) 56 generates, on the basis of the calculated self-position, the update information item for the relative-position tree, that is, the tree-configuration information item P shown in FIG. 6, and executes the processes of updating the relative-position information item corresponding to one of the links in the relative-position tree.

Specifically, as shown in FIG. 6, the tree-configuration information item P is constituted by an update information item for the relative position of the nodes of the self-position origin and the apparatus origin.

Meanwhile, the relative-position-tree update module Q (self-position calculator Q) 57 is a relative-position calculator to which, for example, the odometry is applied, whereby a self-position is calculated by utilizing measurement information items that are acquired by the sensor attached to the wheel center 55 set as another most-downstream node in the relative-position tree, that is, measurement information items of a rotation and a direction (steering angle) of the wheel.

The relative-position-tree update module Q (self-position calculator Q) 57 generates, on the basis of the calculated self-position, the update information item for the relative-position tree, that is, the tree-configuration information item Q shown in FIG. 6, and executes the processes of updating the relative-position information item corresponding to the one of the links in the relative-position tree.

Specifically, as shown in FIG. 6, the tree-configuration information item Q is constituted by another update information item for the relative position of the nodes of the self-position origin and the apparatus origin.

In this way,

Relative-position-tree update module P (self-position calculator P) 56, and

Relative-position-tree update module Q (self-position calculator Q) 57,

these two modules each generate an information item of a relative position of the same pair of nodes as an update information item.

However, these two relative-position information items are calculated not only with use of the sensors attached to the different positions but also by application of the different algorithms, and hence generated as inconsistent relative-position information items in many cases.

Specifically, the relative-position-tree update module P (self-position calculator P) 56 uses, as the sensor for the position calculation, the camera 54 set as the most-downstream mode in the relative-position tree, and calculates the self-position on the basis of the images captured by this camera.

As in the example described with reference to FIG. 2, the camera is attached to a center position of a top of the vehicle.

The relative-position-tree update module P (self-position calculator P) 56, to which the algorithm based on the SLAM is applied, calculates the position of the camera 54 as the apparatus origin.

Similarly, the relative-position-tree update module Q (self-position calculator Q) 57 calculates the self-position by using, as the sensor for the position calculation, the measurement information items of the rotation and the direction of the wheel from the sensor attached to the wheel center 55 set as the most-downstream node in the relative-position tree.

As in the example described with reference to FIG. 2, in this case, the sensor is attached to a center position of the wheel.

The relative-position-tree update module Q (self-position calculator Q) 57, to which the position-calculation algorithm based on the odometry is applied, calculates the position of the wheel center 55 as the apparatus origin.

In this way,

Relative-position-tree update module P (self-position calculator P) 56, and Relative-position-tree update module Q (self-position calculator Q) 57 these two modules respectively calculate the positions of the apparatus origins on the basis of the information items from the sensors attached to the different positions (camera and rotation-and-direction measuring instrument at the center portion of the wheel), and by applying the different algorithms. As a result, the tree-configuration information items (update information items) that the modules calculate are inconsistent and conflict with each other, and the processes of updating the relative-position tree are difficult to exert.

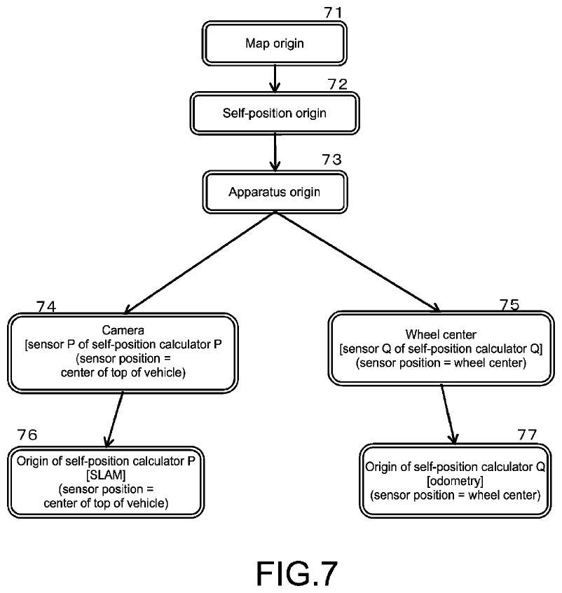

Next, with reference to FIG. 7 and subsequent figures, the configuration that solves the above-described problem is described.

FIG. 7 is a diagram showing a configuration example of the relative-position tree to be utilized in the procedure according to the embodiment of the present disclosure.

The relative-position tree shown in FIG. 7 is constituted by seven nodes of a map origin 71, a self-position origin 72, an apparatus origin 73, a camera 74, a wheel center 75, an origin 76 of the self-position calculator P, and an origin 77 of the self-position calculator Q. The connection links between the nodes each indicate that an information item of a relative position of the nodes with the link set therebetween is stored in the storage unit.

This tree corresponds to the relative-position tree stored in the storage unit in the movable apparatus.

Of the nodes constituting the relative-position tree shown in FIG. 7, five nodes other than most-downstream nodes, that is, the map origin 71, the self-position origin 72, the apparatus origin 73, the camera 74, and the wheel center 75, and settings of the links therebetween are similar to those on the related-art relative-position tree described above with reference to FIG. 6.

The relative-position tree to be utilized in the procedure according to the embodiment of the present disclosure is constituted by adding, as the two most-downstream nodes, that is, the origin 76 of the self-position calculator P and the origin 77 of the self-position calculator Q to the related-art relative-position tree.

The origin 76 of the self-position calculator P, which is one of the most-downstream nodes, has a position information item of an origin position of the self-position calculator P that calculates a self-position by utilizing the camera 74 being a node on an upstream side with respect thereto as a sensor.

The self-position calculator P is, for example, a self-position calculator that performs the self-position calculation on the basis of images captured by the camera 74 and of the SLAM algorithm.

Further, the origin 77 of the self-position calculator Q, which is another one of the most-downstream nodes, has a position information item of an origin position of the self-position calculator Q that calculates a self-position by utilizing, for example, the wheel-rotation-and-direction measuring instrument as a sensor, which is attached to the wheel center 75 being a node on the upstream side with respect thereto.

The self-position calculator Q is, for example, a self-position calculator that performs the self-position calculation on the basis of results of the measurement by the wheel-rotation-and-direction measuring instrument which is attached to the wheel center 75, and on the basis of the odometory algorithm.

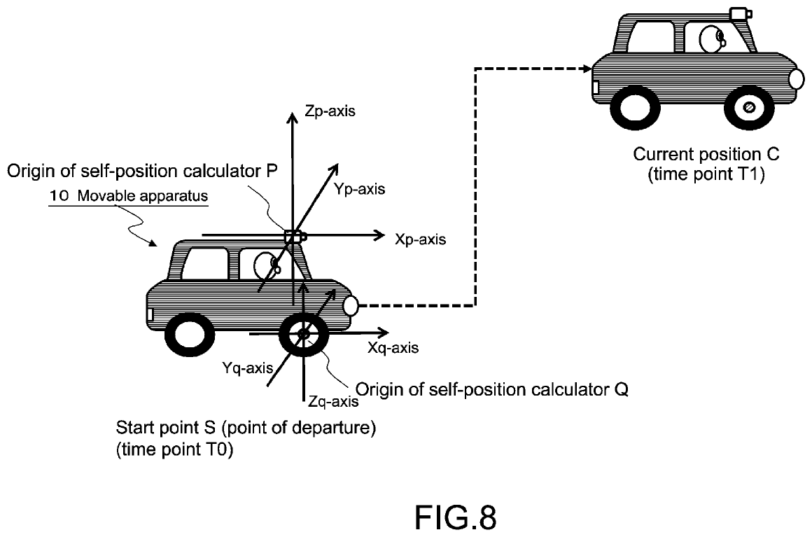

With reference to FIG. 8, functions of the origin 76 of the self-position calculator P and the origin 77 of the self-position calculator Q, which are added as the two most-downstream nodes, are described.

The “origins of the self-position calculators” each refer to a position that the self-position calculator sets as an origin (reference point) at the time of calculating the self-position. When errors are not taken into consideration, the origins of the self-position calculators correspond to stationary positions in a global coordinate system such as a coordinate system of the Earth.

For example, as shown in FIG. 8, the movable apparatus 10 departs and starts to move from the start point S at a time point T0, and has moved to a current position C at a time point T1. Examples of the origin of the self-position calculator P and the origin of the self-position calculator Q in this case are also shown in FIG. 8.

In the example shown in FIG. 8, the origin of the self-position calculator P is defined as a camera position corresponding to a sensor position of the self-position calculator P of the movable apparatus at the start point S.

Further, the origin of the self-position calculator Q is defined as a wheel-center position corresponding to a sensor position of the self-position calculator Q of the movable apparatus at the start point S.

In the example shown in FIG. 8, the origin of the self-position calculator P and the origin of the self-position calculator Q are each set as a reference point at a stationary position in the global coordinate system such as the coordinate system of the Earth.

Under the state in which the origins of the self-position calculators are set in this way, when the movable apparatus 10 moves with respect to these origins, how the self-position calculators have moved, that is, relative positions of current positions of the self-position calculators and the origins of the self-position calculators can be accurately acquired.

Referring back to FIG. 7, a link between two nodes on the lower left-hand side of the relative-position tree to be applied to the procedure according to the embodiment of the present disclosure, that is, a link between the camera 74 and the origin 76 of the self-position calculator P corresponds to an information item of a relative position of these two nodes.

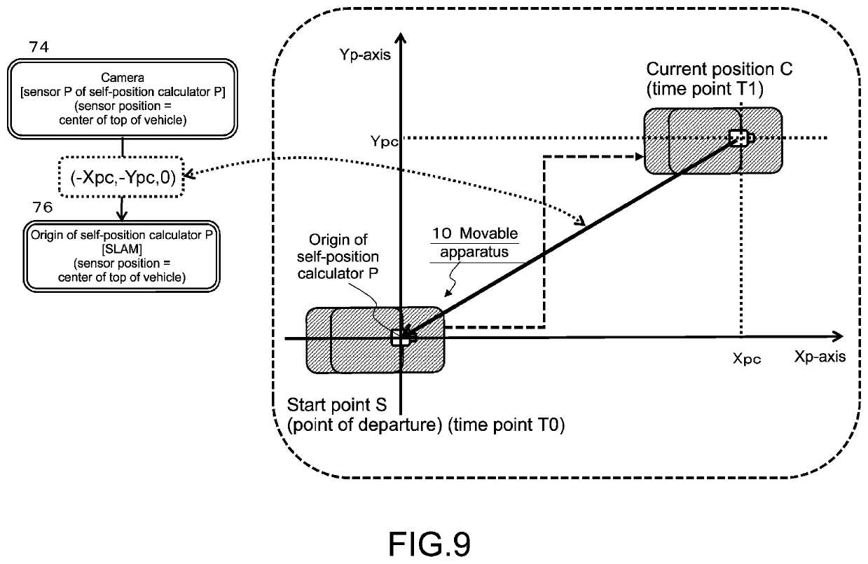

A specific example of the relative-position information item corresponding to this link is described with reference to FIG. 9.

FIG. 9 shows a state in which, as in the description with reference to FIG. 8, the movable apparatus 10 departs and starts to move from the start point S at the time point T0, and has moved to the current position C at the time point T1. The position of the camera being the sensor of the self-position calculator P of the movable apparatus 10 at the start point S in FIG. 9 is the origin of the self-position calculator P.

This origin position is represented as (Xp, Yp)=(0, 0).

Note that, in this example, for the sake of simplicity of description, the movable apparatus 10 does not move in a direction of the Z-axis (perpendicular direction).

Along with the movement of the movable apparatus 10, the position of the camera being the sensor of the self-position calculator P also moves. At the time point T1, under the state in which the movable apparatus 10 has moved to the current position C, the position of the camera is located at position coordinates (Xpc, Ypc) as shown in FIG. 9.

The left-hand side of FIG. 9 shows a part of the relative-position tree stored in the storage unit of the movable apparatus 10, that is, a configuration of the link connection between the node of the camera 74, which is the camera being the sensor of the self-position calculator P, and the node of the origin 76 of the self-position calculator P.

The origin 76 of the self-position calculator P corresponds to the position of the camera being the sensor of the self-position calculator P of the movable apparatus 10 at the start point S. The camera 74 corresponds to the position of the camera of the movable apparatus 10 having moved to the current position C, that is, corresponds to the position coordinates (Xpc, YPc).

The link between the node of the camera 74, which is the camera being the sensor of the self-position calculator P, and the node of the origin 76 of the self-position calculator P indicates that the information item of the relative position of the origin 76 of the self-position calculator P with respect to the position of the camera 74 is a data item stored in the storage unit.

As shown in FIG. 9, this relative-position information item corresponds to a difference between the position of the origin 76 of the self-position calculator P at the start point S and the position of the camera of the movable apparatus 10 at the current position C, that is, a difference from the position coordinates (Xpc, YPc).

In other words, position coordinates (−Xpc, −Ypc, 0) indicated at the link part between the two nodes on the left-hand side of FIG. 9 are a data item that should be recorded in the storage unit as the information item of the relative position of the origin 76 of the self-position calculator P with respect to the camera 74, and be updated.

The self-position calculator P, which functions as the relative-position-tree update module, executes a process of this recording and the update processes by itself.

In other words, the self-position calculators successively calculate differences between (that is, relative positions of) the current positions of the sensors corresponding respectively to the self-position calculators, and the origins of these self-position calculators, thereby calculating relative positions corresponding to the links coupling the nodes of the origins of the self-position calculators and the nodes of the sensors that these self-position calculators utilize. In this way, the processes of updating the relative-position tree are executed.

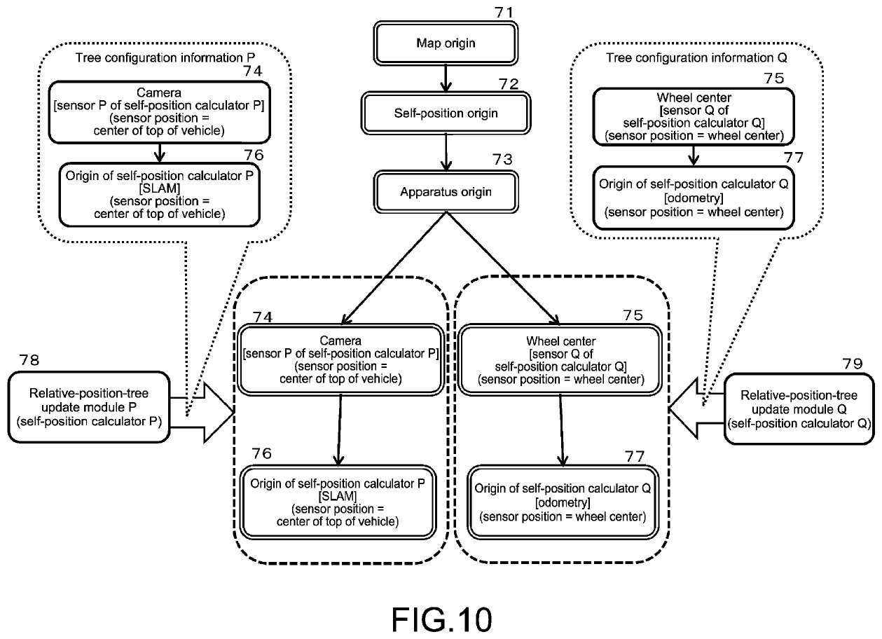

With reference to FIG. 10, a specific example of the processes of updating the relative-position tree is described.

The relative-position tree to be utilized in the procedure according to the embodiment of the present disclosure, which is described above with reference to FIG. 7, is shown at the center part of FIG. 10.

Specifically, the relative-position tree is constituted by the seven nodes of the map origin 71, the self-position origin 72, the apparatus origin 73, the camera 74, the wheel center 75, the origin 76 of the self-position calculator P, and the origin 77 of the self-position calculator Q.

FIG. 10 shows two relative-position-tree update modules.

A relative-position-tree update module P, 78 corresponds to the self-position calculator P.

Further, a relative-position-tree update module Q, 79 corresponds to the self-position calculator Q.

The relative-position-tree update module P (self-position calculator P) 78 is a self-position calculator based, for example, on the SLAM algorithm, which calculates the self-position (that is, position of the sensor P) on the basis of the images captured by the camera (sensor P) installed at the center of the top of the movable apparatus 10 as described with reference to FIG. 8 and FIG. 9.

Meanwhile, the relative-position-tree update module Q (self-position calculator Q) 79 is a self-position calculator based, for example, on the odometry algorithm, which calculates the self-position (that is, position of the sensor Q) on the basis of the information items acquired by the rotation-and-direction measuring instrument (sensor Q) installed at the wheel center of the movable apparatus 10 as described with reference to FIG. 8.

As shown in FIG. 10, these self-position calculators P and Q as the relative-position-tree update modules 78 and 79 update the parts of the relative-position tree stored in the storage unit.

As shown in FIG. 10, the relative-position-tree update module P (self-position calculator P) 78 successively calculates the differences between (that is, relative positions of) the current positions of the camera corresponding to the self-position calculator P, and the origin of the self-position calculator P, thereby calculating the relative position corresponding to the link coupling the node of the camera 74 and the node of the origin 76 of the self-position calculator P in the relative-position tree. In this way, the processes of updating the relative-position tree are executed.

Further, the relative-position-tree update module Q (self-position calculator Q) 79 successively calculates the differences between (that is, relative positions of) the current positions of the wheel center corresponding to the sensor position of the self-position calculator Q, and the origin of the self-position calculator Q, thereby calculating the relative position corresponding to the link coupling the node of the wheel center 75 and the node of the origin 77 of the self-position calculator Q in the relative-position tree. In this way, the processes of updating the relative-position tree are executed.

In this way, the plurality of relative-position-tree update modules (self-position calculators) each execute the process of updating the relative-position tree only on a configuration of the connection between the nodes corresponding to the positions of the sensor that corresponding one of the self-position calculators being the modules utilizes, and the node of the origin of the corresponding one of the self-position calculators. Thus, the problem of the data conflict as described above with reference to FIG. 5 does not occur.

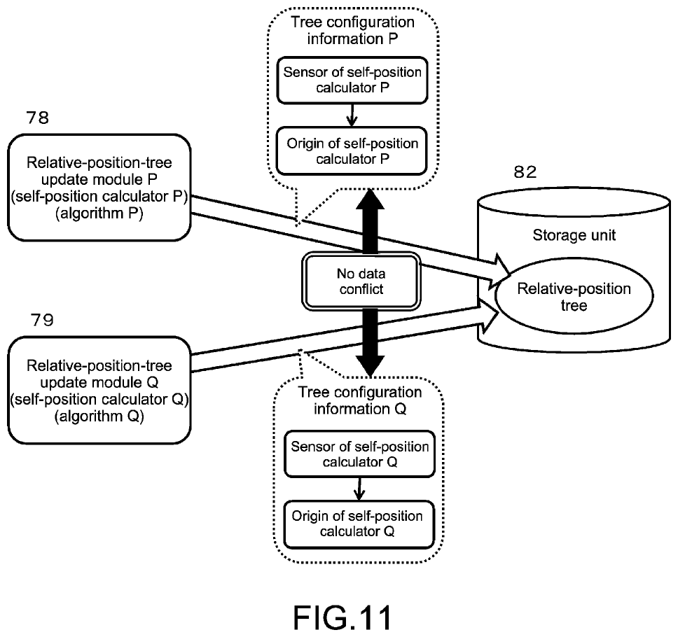

A general example of the processes of updating the relative-position tree, to which the procedure according to the embodiment of the present disclosure is applied, is described with reference to FIG. 11.

FIG. 11 shows the following two modules.

The relative-position-tree update module P, 78, which corresponds to the self-position calculator P, executes the self-position calculation procedure based on the algorithm P by utilizing the sensor of the self-position calculator P.

The relative-position-tree update module Q, 79, which corresponds to the self-position calculator Q, executes the self-position calculation procedure based on the algorithm Q by utilizing the sensor of the self-position calculator Q.

A storage unit 82 stores a relative-position tree. This relative-position tree is, for example, the relative-position tree described above with reference to FIG. 7.

The relative-position-tree update module P, 78 executes the processes of updating the relative-position tree only on a part of the relative-position tree stored in the storage unit 82, that is,

a configuration of the node connection between the sensor of the self-position calculator P and the origin of the self-position calculator P.

Meanwhile, the relative-position-tree update module Q, 79, executes the processes of updating the relative-position tree only on another part of the relative-position tree stored in the storage unit 82, that is,

a configuration of the node connection between the sensor of the self-position calculator Q and the origin of the self-position calculator Q.

In this way, the plurality of relative-position-tree update modules (self-position calculators) each execute the process of updating the relative-position tree only on a configuration of the connection between the nodes corresponding to the positions of the sensor that corresponding one of the self-position calculators being the modules utilizes, and the node of the origin of the corresponding one of the self-position calculators. Thus, the problem of the data conflict as described above with reference to FIG. 5 does not occur.

Note that, also when three or more relative-position-tree update modules are set, the same processes of updating the relative-position tree as those by the two modules in the example shown in FIG. 11 can be executed without causing the data conflict.

However, the processes of updating the relative-position tree, which are described with reference to FIG. 10 and FIG. 11, are update processes only by downstream nodes in the relative-position tree.

The processes of updating the relative-position tree need to be executed also on nodes on an upstream side.

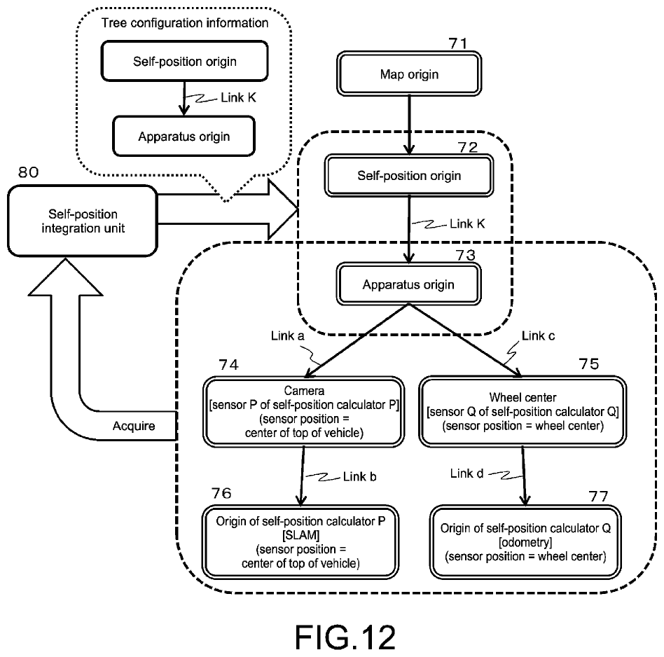

With reference to FIG. 12, processes of updating the data items of the two node of the self-position origin 72 and the apparatus origin 73 in the relative-position tree are described.

Note that, the relative positions of the apparatus origin 73 and sensor nodes (camera 74 and wheel center 75) being nodes on a downstream side with respect thereto are not updated, and hence update processes thereon are unnecessary.

As shown in FIG. 12, the processes of updating the data items of the two nodes of the self-position origin 72 and the apparatus origin 73 in the relative-position tree are executed by a self-position integration unit 80.

The self-position integration unit 80 is a processing unit provided in the movable apparatus 10.

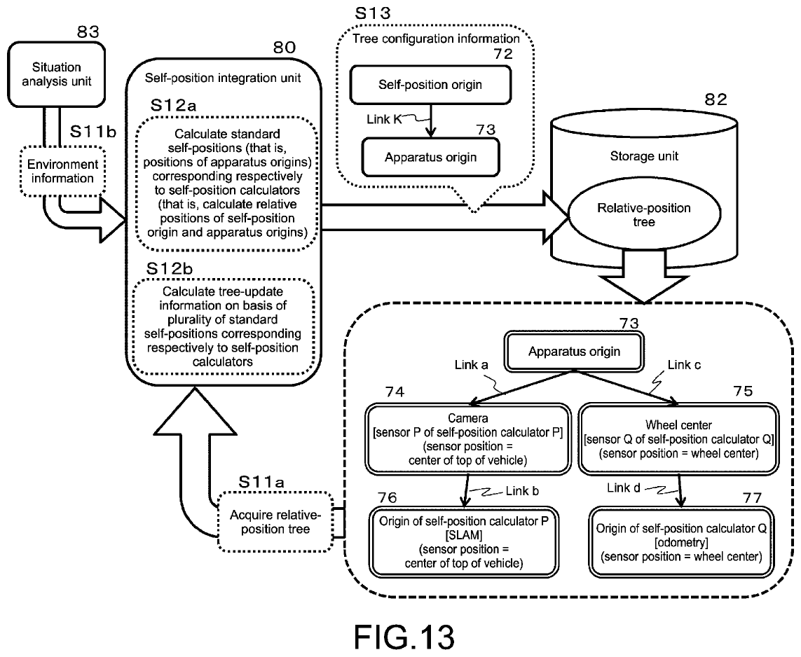

Processes that the self-position integration unit 80 executes are described with reference to FIG. 13 and subsequent figures.

FIG. 13 shows the processes that the self-position integration unit 80 executes in an order of Step S11a to Step S13.

First, in Step S11a, the self-position integration unit 80 reads out the relative-position tree stored in the storage unit 82.

As shown in FIG. 13, data items to be read out are

the data items of the nodes of the apparatus origin 73, the camera 74, the wheel center 75, the origin 76 of the self-position calculator P, and the origin 77 of the self-position calculator Q, that is, data items containing information items of relative positions of these nodes.

In FIG. 13, a link “a,” a link “b,” a link “c,” and a link “d” coupling these nodes are shown. The self-position integration unit 80 acquires information items of relative positions corresponding to these links from the storage unit 82.

Then, in Step S11b, the self-position integration unit 80 receives environment information items from a situation analysis unit 83.

This situation analysis unit 83, which is one of components of the movable apparatus 10, analyzes, for example, brightness on the outside of the movable apparatus 10, environments such as field of vision, and operating conditions of the sensors, and inputs results of these analyses to the self-position integration unit 80.

As described above, the self-position calculators that calculate the self-positions based on the plurality of different algorithms in the procedure according to the embodiment of the present disclosure are attached to the movable apparatus 10.

However, the position information items to be calculated by these self-position calculators have the problem that their accuracies significantly vary depending on environments.

For example, in the SLAM, the processes based on images captured by a camera are executed. Thus, in the environments where clear images of the surroundings are difficult to capture, such as night and heavy rain, the positional accuracy to be calculated degrades.

Further, in the environments where data items from GPS satellites are difficult to reach, such as the environment where a large number of high-rise buildings are built, the positional accuracy to be calculated by the system that utilizes the GPS degrades. Note that, as described above, the procedure according to the embodiment of the present disclosure is not limited the configuration of utilizing the plurality of self-position calculators to which the different algorithms are applied, and is applicable also to the configuration of utilizing the plurality of self-position calculators to which the same algorithm is applied. Even in the configuration of utilizing the plurality of self-position calculators to which the same algorithm is applied, the values calculated by the calculators may be different from each other due, for example, to the difference in attachment position between the self-position calculators, the difference in measurement accuracy between the self-position calculators, and to the measurement errors.

In this way, the self-position calculators vary in performance and availability due to variation or difference in environment. It is difficult to provide a self-position calculator capable of calculating position information items with high accuracy regardless of environment.

Further, once a sensor fails, a self-position calculator depending on the sensor does not function properly any longer.

Note that, as examples of the environment information items, there may be mentioned an information item of an environment on the outside of the movable apparatus, information items of failures of the sensors that the plurality of self-position calculators utilize, and information items of utilization conditions of resources.

The self-position integration unit 80 receives, as the environment information items, the state on the outside of the movable apparatus, the information items from the sensors, and the information items of the resources, and generates an information item of updating the relative-position tree with reference to these information items.

In Step S12a, the self-position integration unit 80 executes processes of calculating standard self-positions corresponding respectively to the self-position calculators.

The standard self-positions correspond to positions of the apparatus origins 73. In other words, these position calculations of the apparatus origins 73 correspond also to processes of calculating relative positions of the self-position origin and the apparatus origins.

In still other words, these position calculations each correspond also to a process of calculating an information item (link K) of a relative position of the nodes of the self-position origin 72 and the apparatus origin 73 being parts of the configuration of the relative-position tree, the information item (link K) being shown in Step S13 in FIG. 13.

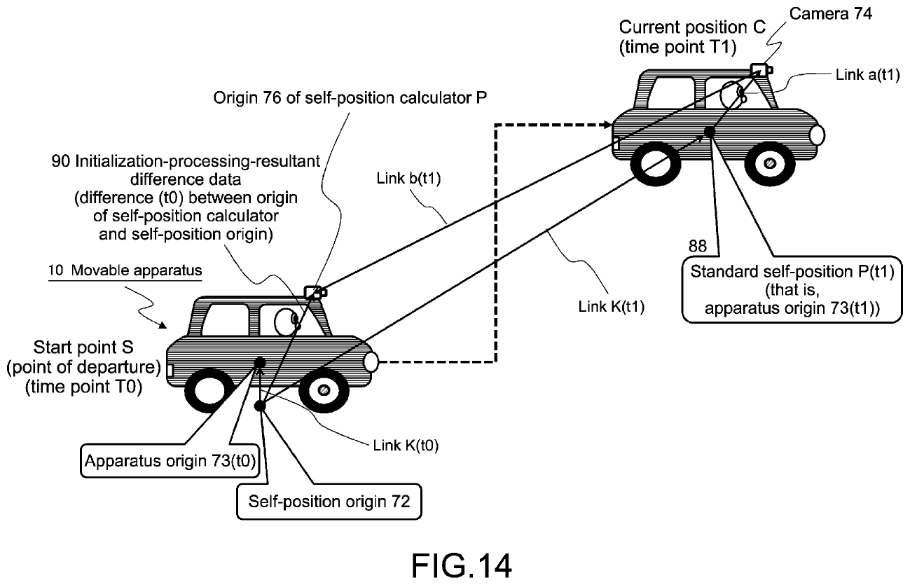

A specific example of the process of Step S12a is described with reference to FIG. 14.

In the example shown in FIG. 14, a standard self-position P, 88 corresponding to the self-position calculator P is calculated.

Note that, in Step S12a, the self-position integration unit 80 executes processes of calculating a plurality of standard self-positions with respect to the plurality of self-position calculators.

In the example shown in FIG. 14, the standard self-position P, 88 corresponding to the self-position calculator P being one of the plurality of self-position calculators is calculated.

FIG. 14 shows the movable apparatus 10 at the start point S (point of departure) at the time point T0, and the movable apparatus 10 at the current position C at the time point T1 thereafter.

In the example shown in FIG. 14, the processes of updating the relative-position tree, which are successively executed, are executed on the basis of values obtained by calculating the standard self-position P, 88 corresponding to the self-position calculator P at the time point T1 when the movable apparatus 10 is at the current position C.

In Step S12a, the self-position integration unit 80 executes a process of calculating the standard self-position P, 88 corresponding to the self-position calculator P. As described above, the standard self-position corresponds to the position of the apparatus origin 73.

In the example shown in FIG. 14, the standard self-position corresponds to a position of an apparatus origin 73(t1) at the time point T1.

Thus, the standard self-position can be specified only by calculating the position of the apparatus origin 73(t1) at the current position C at the time point T1 in FIG. 14.

The position of the apparatus origin 73(t1) at the current position C shown in FIG. 14 can be calculated as a relative position with respect to a position of a self-position origin 72(t0) of the movable apparatus 10 at the start point S shown in FIG. 14.

This relative position corresponds to the link K in the relative-position tree at the time point T1. In other words, this relative position corresponds to the information item (link K) of the relative position of the nodes of the self-position origin 72 and the apparatus origin 73 in the relative-position tree, the information item (link K) being shown in Step S13 in FIG. 13.

Note that, in contrast to the self-position origin 72 being a stationary point that does not move along with the movement of the movable apparatus 10 in accordance with a lapse of time, the apparatus origin 73 moves along with the movement of the movable apparatus 10. Thus, the information item (link K) of the relative position of the nodes of the self-position origin 72 and the apparatus origin 73 in the relative-position tree needs to be successively updated in accordance with the lapse of time.

In FIG. 14, a line connecting the self-position origin 72 and the apparatus origin 73 at the start point S corresponds to a link K(t0) at the time point T0. In FIG. 14, a line connecting the self-position origin 72 at the start point S and the apparatus origin 73 at the current position C corresponds to a link K(t1) at the time point T1.

A relative position shown in FIG. 14, that is, a relative position of the camera 74 of the movable apparatus 10 and the apparatus origin 73 at the current position C at the time point T1 corresponds to the relative-position information item corresponding to the link “a” in the relative-position tree that is acquired from the storage unit 82 shown in FIG. 13.

In FIG. 14, this relative position is indicated as a link a(t1) corresponding to a relative-position information item at the time point T1.

Further, another relative position shown in FIG. 14, that is, a relative position of the camera 74 of the movable apparatus 10 at the current position C at the time point T1 and the camera of the movable apparatus 10 at the start point S at the time point T0, more specifically, a relative position of the camera 74 of the movable apparatus 10 and the origin 76 of the self-position calculator P shown in FIG. 14 corresponds to the relative-position information item corresponding to the link “b” in the relative-position tree that is acquired from the storage unit 82 shown in FIG. 13.

In FIG. 14, this relative position is indicated as a link b(t1) corresponding to another relative-position information item at the time point T1.

Note that, as shown in FIG. 14, a difference between (relative position of) the origin 76 of the self-position calculator P, which corresponds to the position of the camera of the movable apparatus 10 at the start point S (point of departure) at the time point T0, and the self-position origin 72 corresponds to an initialization-processing-resultant difference data item 90.

The initialization-processing-resultant difference data item 90 is calculated and stored in a memory in an initialization process in the movable apparatus 10.

In other words, before starting to move, the movable apparatus 10 executes processes of measuring the difference between (relative position of) the origin 76 of the self-position calculator P and the self-position origin 72, and storing the difference in the memory.

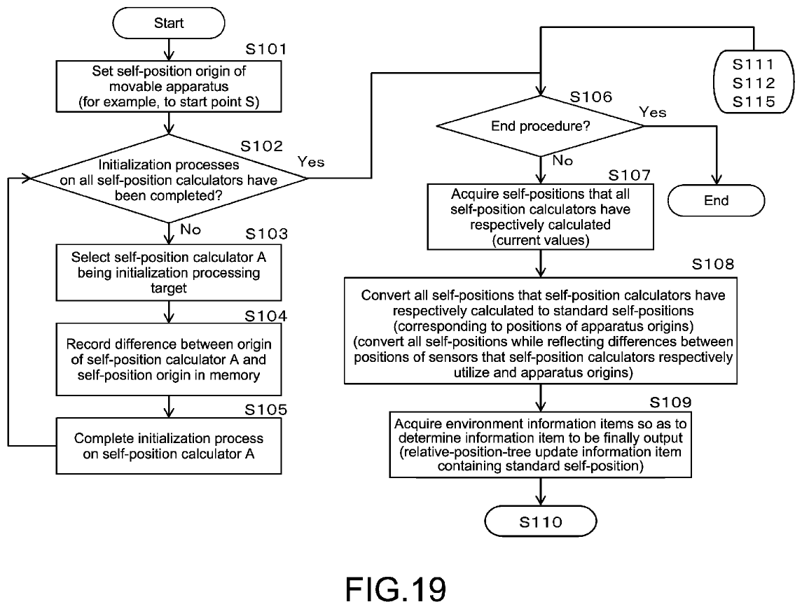

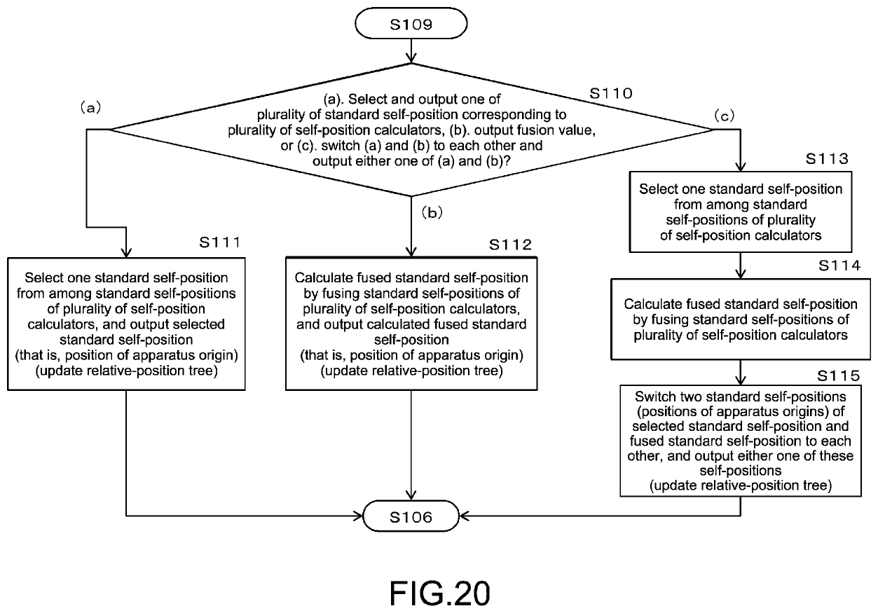

A specific sequence of these processes is described below with reference to the flowcharts shown in FIG. 19 and FIG. 20.

In the process of Step S12a described with reference to FIG. 13, the self-position integration unit 80 calculates the standard self-position P, 88 shown in FIG. 14.

As described above, the standard self-position P, 88 corresponds to the position of the apparatus origin 73(t1) at the current position C shown in FIG. 14. The standard self-position P, 88 can be calculated as the relative position with respect to the position of the self-position origin 72(t0) of the movable apparatus 10 at the start point S.

This relative position corresponds to the link K(t1) in the relative-position tree at the time point T1.

As understood from FIG. 14,

four lines of the link K(t1), the link a(t1), the link b(t1), and the initialization-processing-resultant difference data item 90 form a shape of a closed quadrangle.

Further, a relative position of two nodes of each of the three lines of the link a(t1), the link b(t1), and the initialization-processing-resultant difference data item 90 has already been obtained.

Specifically, relative positions of nodes in the following pairs have already been obtained.

(1) Relative position of nodes that the link a(t1) connects to each other, that is, a relative position of the standard self-position P, 88 (that is, apparatus origin 73(t1)) and the camera 74 at the current position C at the time point T1

(2) Relative position of nodes that the link b(t1) connects to each other, that is, a relative position of the camera 74 at the current position C at the time point T1 and the origin 76 of the self-position calculator P at the start point S at the time point T0

(3) Relative position of nodes that the initialization-processing-resultant difference data item 90 connects to each other, that is, a relative position of the origin 76 of the self-position calculator P and the self-position origin 72 at the start point S at the time point T0

Thus, from relationships of these relative positions, a relative position of nodes that the link K(t1) connects to each other, that is, a relative position of the standard self-position P, 88 at the current position C at the time point T1 (that is, apparatus origin 73(t1)), and the self-position origin 72 at the start point S at the time point T0 can be calculated.

Specifically,

the link K(t1) being the relative position of the standard self-position P, 88 (that is, apparatus origin 73(t1)) with respect to the self-position origin 72 can be calculated by adding the following three obtained relative positions (relative positions 1, 2, and 3).

(Relative Position 1) Relative position of the origin 76 of the self-position calculator P with respect to the self-position origin 72

(Relative Position 2) Relative position of the camera 74 with respect to the origin 76 of the self-position calculator P

(Relative Position 3) Relative position of the standard self-position P, 88 (that is, apparatus origin 73(t1)) with respect to the camera 74

The self-position integration unit 80 calculates the link K(t1) being the relative position of the standard self-position P, 88 (that is, apparatus origin 73(t1)) with respect to the self-position origin 72 by adding information items of the three relative positions.

The relative position information item indicated by this link K(t1) indicates the standard self-position P(t1), 88 corresponding to the self-position calculator P, that is, a position of the apparatus origin 73 at the current position C.

The self-position integration unit 80 calculates the standard self-position P(t1), 88 corresponding to the self-position calculator P on the basis of the processes described with reference to FIG. 14.

Note that, the processes of calculating the standard self-position P(t1), 88, which are described with reference to FIG. 14, are merely an example, and other processes may be employed.

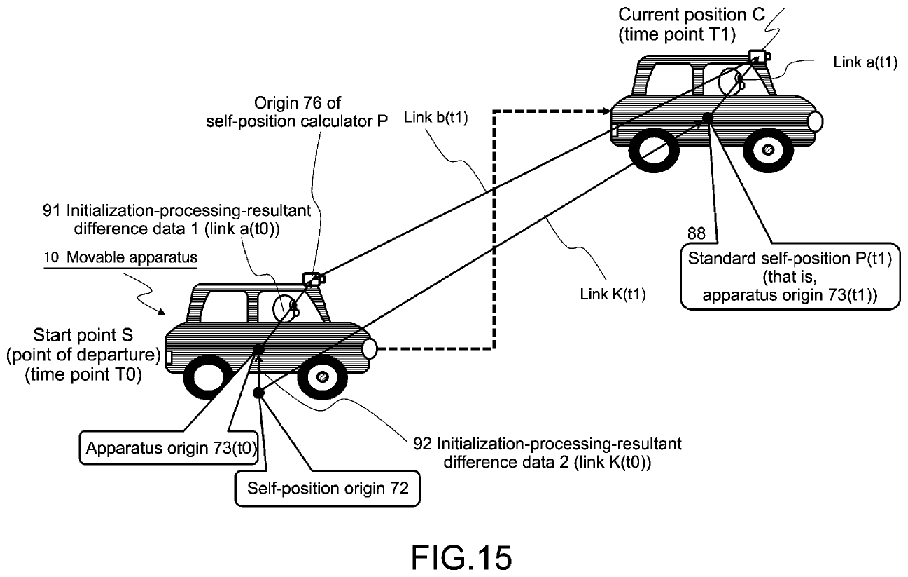

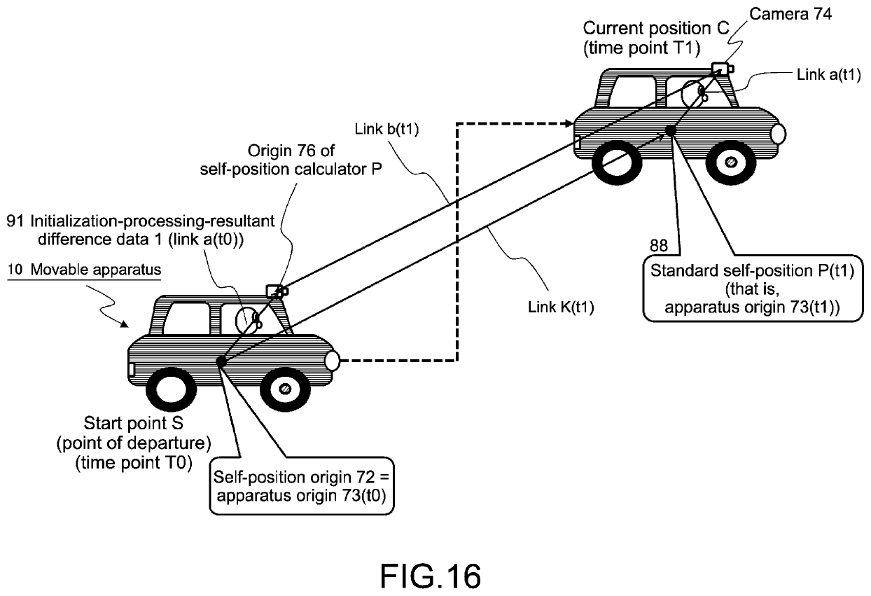

Examples of the different processes are described with reference to FIG. 15 and FIG. 16.

First, the processes in the example shown in FIG. 15 are described.

The processes in the example shown in FIG. 15 are different from the processes in the example shown in FIG. 14 in that the initialization-processing-resultant difference data item 90 described with reference to FIG. 14 is divided into two difference data items.

In FIG. 15, the following two difference data items are used as initialization-processing-resultant difference data items.

(1) Initialization-processing-resultant difference data item 1, 91 corresponding to a relative position of the origin 76 of the self-position calculator P and an apparatus origin 73(t0) at the start point S at the time point T0

(2) Initialization-processing-resultant difference data item 2, 92 corresponding to a relative position of the apparatus origin 73(t0) and the self-position origin 72 at the start point S at the time point T0 A sum of values of these two difference data items corresponds to the initialization-processing-resultant difference data item 90 described with reference to FIG. 14.

These two difference data items shown in FIG. 15 may be calculated at the time of the initialization process such that the standard self-position P(t1), 88 may be calculated by utilizing these data items.

Next, the processes in the example shown in FIG. 16 are described.

In the processes in the example shown in FIG. 16, the self-position origin 72 of the movable apparatus 10 and the apparatus origin 73(t0) at the start point S at the time point T0 are set consistent with each other.

In this case, as shown in FIG. 16, the standard self-position P(t1), 88 can be calculated by using only the following difference data item.

(1) Initialization-processing-resultant difference data item 1, 91 corresponding to the relative position of the origin 76 of the self-position calculator P and the self-position origin 72 (that is, apparatus origin 73(t0)) at the start point S at the time point T0

In this way, various processes can be employed as the processes of calculating the standard self-position P(t1), 88.

Note that, by processes similar to the processes of calculating the standard self-position corresponding to the self-position calculator P, which are described with reference to FIG. 14 to FIG. 16, the self-position integration unit 80 also calculates a standard self-position Q corresponding to the self-position calculator Q.

The processes of calculating the standard self-position Q can be executed with use of the relative position information items corresponding to the links “c” and “d” in the relative-position tree that is acquired from the storage unit 82 shown in FIG. 13.

In this way, the self-position integration unit 80 calculates standard self-positions corresponding to all the self-position calculators.

All the standard self-positions corresponding to all the self-position calculators, which the self-position integration unit 80 calculates, are the position of the apparatus origin 73 at the current position C (relative position with respect to the self-position origin 72). Thus, the information items of these positions should be intrinsically the same as each other.

However, these standard self-positions are calculated respectively by the different self-position calculators on the basis of their respective different position-calculation algorithms.

For example, the self-position calculator P performs the self-position calculation based on the SLAM algorithm, and the self-position calculator Q performs the self-position calculation based on the odometry algorithm.

These algorithms are different processes. As a result, the standard self-positions that the self-position calculators respectively calculate are different from each other.

In addition, in a dark environment, there occurs variation in accuracy depending on environments, such as degradation in accuracy of the position calculation processes based on the SLAM algorithm with use of images captured by a camera.

Further, there may occur degradation in accuracy due, for example, to the failures of the sensors.

In consideration of such risks, in Step S12b, the self-position integration unit 80 calculates, on the basis of the plurality of standard self-positions corresponding to the plurality of self-position calculators, which the self-position integration unit 80 calculates in Step S12a, a standard self-position to be finally applied to the update of the tree, that is, the relative position of the self-position origin 72 and the apparatus origin 73, which corresponds to the link K.

There are various patterns of the process that the self-position integration unit 80 executes in Step S12b, that is, the process of determining the standard self-position to be finally applied to the update of the tree.

Specifically, there are patterns of the following three types (a), (b), and (c).

(a) Process of selecting and determining one standard self-position from among the plurality of standard self-positions corresponding to the plurality of self-position calculators as the standard self-position to be applied to the update of the tree

(b) Process of generating the standard self-position to be applied to the update of the tree by fusing the plurality of standard self-positions corresponding to the plurality of self-position calculators

(c) Process of determining the standard self-position to be applied to the update of the tree by switching the processes (a) and (b) to each other depending on situations

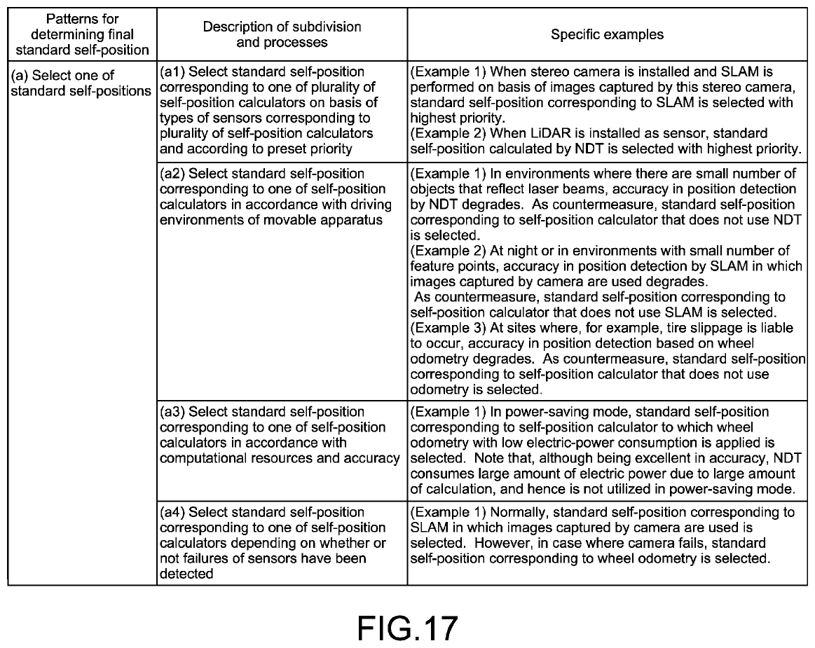

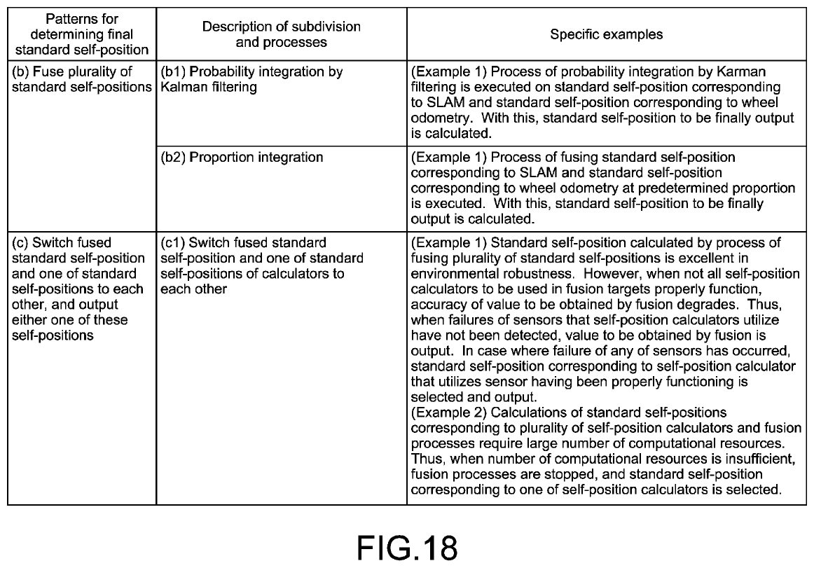

Now, specific examples of the processing patterns (a) to (c) are described with reference to FIG. 17 and FIG. 18.

First, with reference to FIG. 17,

the specific example of the following process (a) is described.

(a) Process of selecting and determining one standard self-position from among the plurality of standard self-positions corresponding to the plurality of self-position calculators as the standard self-position to be applied to the update of the tree

As shown in FIG. 17, this process (a) can be subdivided into four processing patterns (a1), (a2), (a3), and (a4).

Now, these processes are described.

(a1) A standard self-position corresponding to one of the plurality of self-position calculators is selected on the basis of types of the sensors corresponding to the plurality of self-position calculators and according to a preset priority.

The following examples can be mentioned as specific examples of this process.

### Example 1

When a stereo camera is installed, and the SLAM is performed on the basis of images captured by this stereo camera, a standard self-position corresponding to the SLAM is selected with a highest priority.

### Example 2

When the LiDAR is installed as a sensor, a standard self-position calculated by the NDT is selected with a highest priority.

(a2) A standard self-position corresponding to one of the self-position calculators is selected in accordance with driving environments of the movable apparatus.

The following examples can be mentioned as specific examples of this process.

### Example 1

In environments where there are a small number of objects that reflect laser beams, an accuracy in position detection by the NDT degrades. As a countermeasure, a standard self-position corresponding to the self-position calculator that does not use the NDT is selected.

### Example 2

At night or in environments with a small number of feature points, an accuracy in position detection by the SLAM in which images captured by a camera are used degrades. As a countermeasure, a standard self-position corresponding to the self-position calculator that does not use the SLAM is selected.

### Example 3

At sites where, for example, tire slippage is liable to occur, an accuracy in position detection based on the wheel odometry degrades. As a countermeasure, a standard self-position corresponding to the self-position calculator that does not use the odometry is selected.

(a3) A standard self-position corresponding to one of self-position calculators is selected in accordance with computational resources and accuracy.

The following example can be mentioned as a specific example of this process.

### Example 1

In a power-saving mode, a standard self-position corresponding to the self-position calculator to which the wheel odometry with low electric-power consumption is applied is selected. Note that, although being excellent in accuracy, the NDT consumes a large amount of electric power due to a large amount of calculation, and hence is not utilized in the power-saving mode.

(a4) A standard self-position corresponding to one of the self-position calculators is selected depending on whether or not failures of sensors have been detected.

The following example can be mentioned as a specific example of this process.

### Example 1

Normally, the standard self-position corresponding to the SLAM in which images captured by a camera are used is selected. However, in case where the camera fails, the standard self-position corresponding to the wheel odometry is selected.

Next, with reference to FIG. 18, specific examples of the following processes (b) and (c) are described.

(b) Process of generating the standard self-position to be applied to the update of the tree by fusing the plurality of standard self-positions corresponding to the plurality of self-position calculators

(c) Process of determining the standard self-position to be applied to the update of the tree by switching the processes (a) and (b) to each other depending on situations

As shown in FIG. 18, the process (b) can be subdivided into two processing patterns (b1) and (b2).

Now, these processes are described.

(b1) Probability integration by Kalman filtering is performed.

The following example can be mentioned as a specific example of this process.

### Example 1

A process of the probability integration by Karman filtering is executed on the standard self-position corresponding to the SLAM and the standard self-position corresponding to the wheel odometry. With this, a standard self-position to be finally output is calculated.

(b2) Proportion integration is performed.

The following example can be mentioned as a specific example of this process.

### Example 1

A process of fusing the standard self-position corresponding to the SLAM and the standard self-position corresponding to the wheel odometry at a predetermined proportion is executed. With this, a standard self-position to be finally output is calculated.

Next, the following process is described.

(c) Process of determining the standard self-position to be applied to the update of the tree by switching the processes (a) and (b) to each other depending on situations

This process corresponds to the following process.

(c1) Process of switching the one standard self-position selected from the standard self-positions of the calculators and the fused standard self-position to each other.

The following example can be mentioned as a specific example of this process.

### Example 1

The standard self-position calculated by the process of fusing the plurality of standard self-positions is excellent in environmental robustness. However, when not all the self-position calculators to be used in the fusion do not properly function, an accuracy of a value to be obtained by the fusion degrades.

Thus, when failures of the sensors that the self-position calculators utilize have not been detected, the value to be obtained by the fusion is output. In case where a failure of any of the sensors has occurred, the standard self-position corresponding to a self-position calculator that utilizes a sensor having been properly functioning is selected and output.

### Example 2

The calculations of the standard self-positions corresponding to the plurality of self-position calculators and the fusion processes require a large number of computational resources. Thus, when the number of the computational resources is insufficient, the fusion processes are stopped, and the standard self-position corresponding to the one of the self-position calculators is selected.

In this way, in Step S12b shown in FIG. 13, the self-position integration unit 80 executes any of the following processes (a) to (c) described with reference to FIG. 17 and FIG. 18. With this, one standard self-position to be finally applied to the processes of updating the relative-position tree is determined from among the plurality of standard self-positions corresponding to the plurality of self-position calculators.

(a) Process of selecting and determining one standard self-position from among the plurality of standard self-positions corresponding to the plurality of self-position calculators as the standard self-position to be applied to the update of the tree

(b) Process of generating the standard self-position to be applied to the update of the tree by fusing the plurality of standard self-positions corresponding to the plurality of self-position calculators

(c) Process of determining the standard self-position to be applied to the update of the tree by switching the processes (a) and (b) to each other depending on situations

Next, in Step S13 shown in FIG. 13, by utilizing the standard self-position to be applied to the processes of updating the relative-position tree, which is determined in Step S12b, the self-position integration unit 80 executes the processes of updating the parts of the configuration of the relative-position tree stored in the storage unit 82, that is,

a configuration of the node connection between the self-position origin 72 and the apparatus origin 73.

Note that, the standard self-position calculated in Step S12b corresponds to the position information item of the apparatus origin 73, specifically, to the relative position of the apparatus origin 73 with respect to the position of the self-position origin 72, that is, the relative-position information item corresponding to the link K indicated in the node configuration in Step S13 in FIG. 13.

In other words, in Step S13, the standard self-position determined in Step S12b is stored as the relative-position information item corresponding to the link K between the self-position origin 72 and the apparatus origin 73 in the relative-position tree stored in the storage unit 82.

By these processes, the relative-position tree stored in the storage unit 82 is updated without problems.

Note that, the processes of updating the relative-position tree stored in the storage unit 82 are successively and regularly executed along with the movement of the movable apparatus 10, and the relative-position tree is constantly overwritten by data items corresponding to latest positions of the movable apparatus 10.

The relative-position tree stored in the storage unit 82 is utilized by the relative-position-tree utilization modules of the movable apparatus 10.

As an example of the relative-position-tree utilization modules, there may be mentioned an action determination unit that determines the movement path of the movable apparatus 10.

An information item of the path that the action determination unit has determined is output to a driving control unit. The driving control unit generates, on the basis of this path information item, a driving-control information item for driving the movable apparatus 10, and outputs the generated driving-control information item to a wheel-driving unit or a walking unit, specifically, to a driving unit including an accelerator, brakes, a steering wheel so as to cause the movable apparatus 10 to move along the determined path.

(4. Sequence of Processes that Movable Apparatus Executes)

Next, with reference to the flowcharts shown in FIG. 19 and FIG. 20, a sequence of the processes that the movable apparatus executes is described.

The processes in the flowcharts shown in FIG. 19 and FIG. 20 can be executed, for example, by data processing units in the movable apparatus in accordance with programs stored in the storage unit.

The data processing unit each include hardware having a program execution function, such as a CPU.

Note that, all the processes in the flowcharts shown in FIG. 19 and FIG. 20 may be executed as the processes by the self-position integration unit 80 being one of the data processing units of the movable apparatus, or may be executed as processes that utilize the self-position integration unit 80 and other ones of the data processing units.

Now, processes of steps in the flowcharts are described.

(Step S101)

First, in Step S101, the movable apparatus sets the self-position origin of the movable apparatus.

As described above with reference to FIG. 1, for example, the start point S being the point of departure of the movable apparatus is set as the self-position origin.

Note that, the example of FIG. 1 is an example of settings of the self-position origin, and hence other points such as the map origin may be set as the self-position origin.

However, the self-position origin needs to be set as the stationary point that does not move along with the movement of the movable apparatus.

(Step S102)

Next, in Step S102, whether or not initialization processes on all the self-position calculators attached to the movable apparatus have been completed is checked.

The plurality of self-position calculators that calculate self-positions on the basis of the various different algorithms are attached to the movable apparatus.

As examples, there may be mentioned the following self-position calculators.

(1) Self-position calculator that uses the GPS or the GNSS and the IMU in combination with each other

(2) Self-position calculator that utilizes the SLAM

(3) Self-position calculator to which the odometry (wheel odometry) is applied

(4) Self-position calculator that uses the LiDAR or the sonar

In Step S102, whether or not the initialization processes on all the self-position calculators attached to the movable apparatus have been completed is checked.

When all the initialization processes have been completed, the procedure proceeds to Step S106.

When not all the initialization processes have been completed, the procedure proceeds to Step S103.

(Step S103)

When it is determined in Step S102 that not all the initialization processes have been completed, processes of Step S103 to Step S105 are executed as initialization processes on self-position calculators, the initialization processes of which have not been completed.

First, in Step S103, one of the self-position calculators, the initialization processes of which have not been completed, is selected as an initialization processing target.

This self-position calculator being the initialization processing target is defined as a self-position calculator A.

(Step S104)

Next, in Step S104, a difference between an origin of the self-position calculator A and the self-position origin set in Step S101 is recorded in a memory.

For example, when the self-position calculator A is a camera or utilizes the SLAM that enables the detection of the self-position based on images captured by the camera, the origin of the self-position calculator A corresponds to a position of the camera that captures the images. As another example, when the self-position calculator A utilizes the odometry that enables the detection of the self-position based, for example, on the rotation and the direction of the wheel, the origin of the self-position calculator A corresponds to the wheel-center position.

Note that, the initialization process on this self-position calculator is executed before the movable apparatus starts to move.

This process corresponds to the process of calculating the initialization-processing-resultant difference data item 90, which is described above with reference to FIG. 14.

In the example described above with reference to FIG. 14, the initialization process on this self-position calculator is executed at the start point S (point of departure).

When the self-position calculator P in FIG. 14 is the self-position calculator being the initialization processing target, the difference to be calculated in Step S104 corresponds to the difference between the origin 76 of the self-position calculator P and the self-position origin 72, that is, the relative position of the origin 76 of the self-position calculator P and the self-position origin 72.

In Step S104, the difference between the origin of the self-position calculator A, the initialization process of which has not been completed, and the self-position origin set in Step S101, that is, the initialization-processing-resultant difference data item 90 described with reference to FIG. 14 is calculated in this way and recorded in the memory.

Note that, as described above with reference to FIG. 14 to FIG. 16, there are some patterns of the initialization-processing-resultant difference data item, and the initialization-processing-resultant difference data item to be calculated and recorded in the memory may be any of those described with reference to FIG. 14 to FIG. 16.

(Step S105)

When the process of Step S104 is completed, the initialization process on the self-position calculator A is completed in Step S105. Then, the procedure returns to Step S102, and the processes of Step S103 to Step S105 are executed on other ones of the self-position calculators, the initialization processes of which have not been completed.

When it is determined in Step S102 that the initialization processes on all the self-position calculators have been completed, the procedure proceeds to Step S106.

(Step S106)

In Step S106, whether or not to end the self-position calculation procedure is determined. When it is determined to end the procedure, the procedure is ended.

When the self-position calculation procedure is continued, the procedure proceeds to Step S107.

(Step S107)

In Step S107, the self-position integration unit 80 acquires the self-positions that all the self-position calculators attached to the movable apparatus have calculated, that is, current self-positions.

For example, in the example described with reference to FIG. 12 and FIG. 13, the self-position integration unit 80 acquires the plurality of self-positions (current values) that the plurality of following self-position calculators have respectively calculated.

(P) Self-position calculator P that executes the SLAM algorithm based on images captured by a camera

(Q) Self-position calculator Q that executes the odometry algorithm based on the information items that the wheel-rotation-and-direction measuring instrument attached to the wheel center have detected

(Step S108)

Next, in Step S108, the self-position integration unit 80 converts all the self-positions that the self-position calculators have respectively calculated to the standard self-positions (corresponding to positions of the apparatus origins).

The standard self-positions refer to the information items each corresponding to a center portion of the movable apparatus, such as the current position of the apparatus origin.

In other words, the self-positions that the self-position calculators have respectively calculated are the positions of the sensors that the self-position calculators respectively utilize, that is, the individual sensor positions of the self-position calculators, such as the camera position and the wheel-center position, and hence are inconsistent with each other.

In Step S108, the individual sensor positions of the self-position calculators, that is, the self-positions that the self-position calculators have respectively calculated are converted to the standard self-positions corresponding to the positions of the movable apparatus (corresponding to positions of the apparatus origins).

At the time of this conversion from the self-positions to the standard self-positions, a process in consideration of the differences between (relative positions of) the sensor positions of the self-position calculators and the apparatus origins is executed.

Specifically, in the example of FIG. 14, the difference between (relative position of) the sensor position of the self-position calculator and the apparatus origin corresponds to the link “a.”

A value of the link “a” is calculated by the initialization process at the start point S, that is, the initialization process executed in Step S103 to Step S105, and stored in the memory.

In this way, in Step S108, the individual sensor positions of the self-position calculators, that is, the self-positions that the self-position calculators have respectively calculated are converted to the standard self-positions corresponding to the positions of the movable apparatus (corresponding to positions of the apparatus origins).

In the example described with reference to FIG. 12 to FIG. 14, the following two self-position calculators calculate the two self-positions.

(P) Self-position calculator P that executes the SLAM algorithm based on images captured by a camera

(Q) Self-position calculator Q that executes the odometry algorithm based on the information items that the wheel-rotation-and-direction measuring instrument attached to the wheel center have detected

In Step S108, the self-position integration unit 80 converts each of the self-positions that these two self-position calculators have respectively calculated to the standard self-position.

The standard self-positions obtained from the self-positions that the plurality of these self-position calculators have calculated reflect the differences between the sensor positions and the apparatus origins (such as vehicle centers).

Thus, the standard self-positions obtained from the self-positions that all the self-position calculators have calculated should be position information items consistent with each other, that is, a position information item of a single apparatus origin (such as vehicle center) should be calculated. However, actually, the values of these position information items are inconsistent with each other, and hence the values of the standard self-positions obtained from the calculated self-positions corresponding respectively to the self-position calculators are inconsistent with each other.

This is not only because the self-position calculators have calculated the self-positions on the basis of the respective different algorithms, but also because the self-position calculators may significantly vary in accuracy depending on environments where the self-position calculation procedure is executed.

Specifically, at night or in the environments with a small number of feature points, the accuracy in position detection by the SLAM in which images captured by a camera are used degrades. Further, at the sites where, for example, tire slippage is liable to occur, the accuracy in position detection based on the wheel odometry degrades.

In such situations, the values of the standard self-positions obtained from the self-positions that the self-position calculators have respectively calculated are inconsistent with each other in many cases.

(Step S109)

After the standard self-positions being the data items obtained by the conversion of the self-positions that the plurality of self-position calculators have calculated are calculated in Step S108, in Step S109, the self-position integration unit 80 receives environment information items so as to execute the process of determining an information item to be output, which contains one of the standard self-positions, as a data item to be finally output, that is, the relative-position-tree update information item.

This process corresponds to the process of Step S11b described above with reference to FIG. 13, that is, a process of receiving the environment information items from the situation analysis unit 83.

This situation analysis unit 83, which is one of the components of the movable apparatus 10, analyzes, for example, the brightness on the outside of the movable apparatus 10, the environments such as field of vision, the operating conditions of the sensors, and the utilization conditions of the resources, and inputs the results of these analyses to the self-position integration unit 80.

As described above, the self-position calculators that calculate the self-positions based on the plurality of different algorithms in the procedure according to the embodiment of the present disclosure are attached to the movable apparatus 10.

However, the position information items to be calculated by these self-position calculators have the problem that their accuracies significantly vary depending on environments.

For example, in the SLAM, the processes based on images captured by a camera are executed. Thus, in the environments where clear images of the surroundings are difficult to capture, such as night and heavy rain, the positional accuracy to be calculated degrades.

Further, in the environments where data items from GPS satellites are difficult to reach, such as the environment where a large number of high-rise buildings are built, the positional accuracy to be calculated by the system that utilizes the GPS degrades.

In this way, the self-position calculators vary in performance and availability due to variation or difference in environment. It is difficult to provide a self-position calculator capable of calculating position information items with high accuracy regardless of environment.

Further, once a sensor fails, a self-position calculator depending on the sensor does not function properly any longer.

The self-position integration unit 80 receives, as the environment information items, not only the state on the outside of the movable apparatus and the information items from the sensors, but also the utilization conditions of the resources, and generates the information item of updating the relative-position tree with reference to these information items.

(Step S110)

In Step S110, on the basis of the environment information items input in Step S109, the self-position integration unit 80 determines a pattern for outputting the relative-position-tree update information item containing the position information item of the standard self-position (apparatus origin).

As specific examples of the pattern for outputting the position information item of the standard self-position (apparatus origin), there are patterns of the following three types (a), (b), and (c) described above with reference to FIG. 17 and FIG. 18.

(a) Process of selecting and determining one standard self-position from among the plurality of standard self-positions corresponding to the plurality of self-position calculators as the standard self-position to be applied to the update of the tree

(b) Process of generating the standard self-position to be applied to the update of the tree by fusing the plurality of standard self-positions corresponding to the plurality of self-position calculators

(c) Process of determining the standard self-position to be applied to the update of the tree by switching the processes (a) and (b) to each other depending on situations

In Step S110, on the basis of the environment information items, the self-position integration unit 80 determines in which of the plurality of above-mentioned patterns (a) to (c) to output the standard self-position.

Note that, the self-position integration unit 80 also determines, on the basis of the received environment information items, in which of the plurality of processing patterns ((a1) to (a4) and (b1) to (b2)) that the patterns (a) and (b) respectively include as described with reference to FIG. 17 and FIG. 18 to output the standard self-position.

When the self-position integration unit 80 determines, on the basis of the environment information items, to execute

(a) Process of selecting and determining one standard self-position from among the plurality of standard self-positions corresponding to the plurality of self-position calculators as the standard self-position to be applied to the update of the tree,

the self-position integration unit 80 executes a process of Step S111.

When the self-position integration unit 80 determines, on the basis of the environment information items, to execute

(b) Process of generating the standard self-position to be applied to the update of the tree by fusing the plurality of standard self-positions corresponding to the plurality of self-position calculators,

the self-position integration unit 80 executes a process of Step S112.

When the self-position integration unit 80 determines, on the basis of the environment information items, to execute

(c) Process of determining the standard self-position to be applied to the update of the tree by switching the processes (a) and (b) to each other depending on situations, the self-position integration unit 80 executes processes of Step S113 to Step S115.

(Step S111)

When the self-position integration unit 80 determines, on the basis of the environment information items, to execute

(a) Process of selecting and determining one standard self-position from among the plurality of standard self-positions corresponding to the plurality of self-position calculators as the standard self-position to be applied to the update of the tree,

the self-position integration unit 80 executes the process of Step S111.

In Step S111, the self-position integration unit 80 selects one standard self-position from among the standard self-positions of the plurality of self-position calculators, and outputs the selected standard self-position (that is, position of an apparatus origin). In other words, the self-position integration unit 80 outputs the relative-position-tree update information item, and executes the processes of updating the relative-position tree stored in the storage unit.

Specifically, the self-position integration unit 80 executes the processes of updating the relative-position tree, which are described above with reference to FIG. 12 and FIG. 13, and the selected standard self-position (that is, position of the apparatus origin) corresponds to the position information item of the node of the apparatus origin 73. The one selected standard self-position corresponds to the position information item of the apparatus origin 73, specifically, to the relative position of the apparatus origin 73 with respect to the position of the self-position origin 72, that is, the relative-position information item corresponding to the link K indicated in the node configuration in Step S13 in FIG. 13.

In still other words, in Step S111, the one selected standard self-position is stored as the relative-position information item corresponding to the link K between the self-position origin 72 and the apparatus origin 73 in the relative-position tree stored in the storage unit 82.

Note that, as described above with reference to FIG. 17, the process of selecting the one standard self-position from among the standard self-positions corresponding to the plurality of self-position calculators includes the plurality of patterns ((a1) to (a4)). The self-position integration unit 80 determines and executes the processing pattern on the basis of the environment information items.

(Step S112)

Meanwhile, when, in Step S110, the self-position integration unit 80 determines, on the basis of the environment information items, to execute

(b) Process of generating the standard self-position to be applied to the update of the tree by fusing the plurality of standard self-positions corresponding to the plurality of self-position calculators,

the self-position integration unit 80 executes the process of Step S112.

In Step S112, the self-position integration unit 80 calculates the one standard self-position by fusing the standard self-positions of the plurality of self-position calculators, and outputs the one standard self-position. In other words, the self-position integration unit 80 executes the processes of updating the relative-position tree by using the fused standard self-position.

In this case, the fused standard self-position (that is, position of the apparatus origin) corresponds to the position information item of the node of the apparatus origin 73.

The fused standard self-position corresponds to the position information item of the apparatus origin 73, specifically, to the relative position of the apparatus origin 73 with respect to the position of the self-position origin 72, that is, the relative-position information item corresponding to the link K indicated in the node configuration in Step S13 in FIG. 13.

In other words, in Step S112, the fused standard self-position is stored as the relative-position information item corresponding to the link K between the self-position origin 72 and the apparatus origin 73 in the relative-position tree stored in the storage unit 82.

Note that, as described above with reference to FIG. 18, the process of generating the one fused standard self-position from the standard self-positions corresponding to the plurality of self-position calculators includes the plurality of patterns ((b1) to (b4)). The self-position integration unit 80 determines and executes the processing pattern on the basis of the environment information items.

(Step S113)

Further, when, in Step S110, the self-position integration unit 80 determines, on the basis of the environment information items, to execute

(c) Process of determining the standard self-position to be applied to the update of the tree by switching the processes (a) and (b) to each other depending on situations, the self-position integration unit 80 executes the processes of Step S113 to Step S115.

In Step S113, on the basis of the environment information items, the self-position integration unit 80 selects the one standard self-position from among the plurality of standard self-positions corresponding to the plurality of self-position calculators.

Note that, as described above with reference to FIG. 17, the process of selecting the one standard self-position from among the standard self-positions corresponding to the plurality of self-position calculators includes the plurality of patterns ((a1) to (a4)). The self-position integration unit 80 determines and executes the processing pattern on the basis of the environment information items.

(Step S114)

Next, in Step S114, the self-position integration unit 80 calculates the one fused standard self-position by executing the process of fusing the plurality of standard self-positions corresponding to the plurality of self-position calculators.

Note that, as described above with reference to FIG. 18, the process of generating the one fused standard self-position from the standard self-positions corresponding to the plurality of self-position calculators includes the plurality of patterns ((b1) to (b4)). The self-position integration unit 80 determines and executes the processing pattern on the basis of the environment information items.

(Step S115)

Next, the self-position integration unit 80 switches the selected standard self-position selected in Step S113 and the fused standard self-position calculated in Step S114 to each other depending on the environment information items, and outputs either one of these standard self-positions.

The information item to be output is the relative-position-tree update information item.

The standard self-position to be output corresponds to the position information item of the apparatus origin 73, specifically, to the relative position of the apparatus origin 73 with respect to the position of the self-position origin 72, that is, the relative-position information item corresponding to the link K indicated in the node configuration in Step S13 in FIG. 13.

In other words, in Step S115, the selected standard self-position or the fused standard self-position is stored as the relative-position information item corresponding to the link K between the self-position origin 72 and the apparatus origin 73 in the relative-position tree stored in the storage unit 82.

Note that, the switching between the selected standard self-position and the fused standard self-position is performed in accordance, for example, with variation in environment information item to be input.

Specifically, the switching is performed in the processing patterns of (Example 1) and (Example 2) of (c) described above with reference to FIG. 18.

When any of the processes of Step S111, Step S112, and Step S113 to Step S115 is ended, the procedure returns to Step S106.

In Step S106, whether or not to end the self-position calculation procedure is determined. When it is determined to end the procedure, the procedure is ended.

When the self-position calculation procedure is continued, the processes of Step S107 and subsequent steps are repeatedly executed.

The processes of Step S107 and the subsequent steps are executed by utilizing self-position information items that the plurality of self-position calculators have newly acquired.

By repeating these processes, the relative-position tree stored in the storage unit is updated to latest versions, that is, versions in which position information items in accordance with positions to which the movable apparatus has moved are stored.

Information items of the latest relative-position tree stored in the storage unit are utilized by the various relative-position-tree utilization modules as described above with reference to FIG. 4.

Examples of the relative-position-tree utilization modules include the action determination unit that determines the movement path of the movable apparatus. The action determination unit executes, for example, a process of checking a self-position by utilizing the information items of the latest relative-position tree stored in the storage unit, and determining a path thereafter.

(5. Configuration Example of Movable Apparatus)

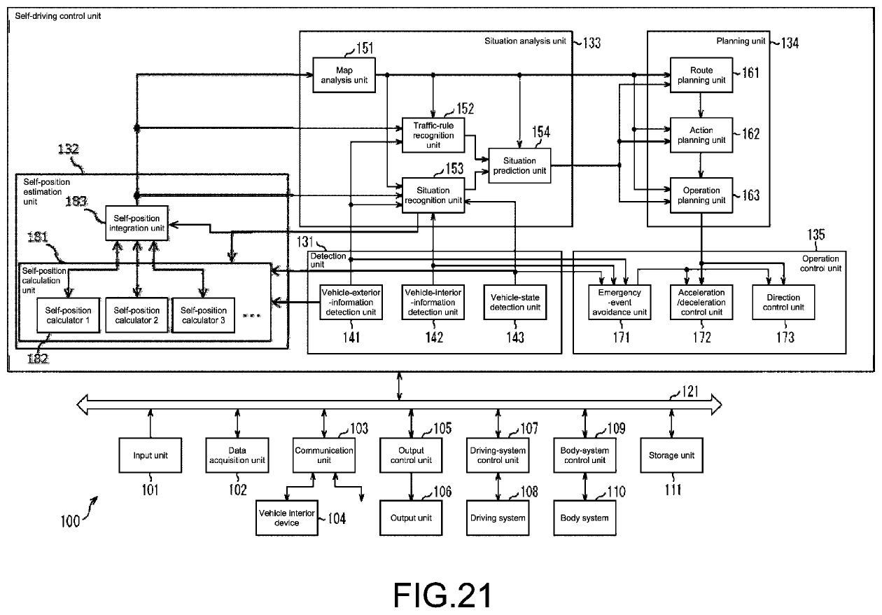

Next, with reference to FIG. 21, a configuration example of the movable apparatus is described.

FIG. 21 is a block diagram showing a schematic functional configuration example of a vehicle control system 100 as an example of a movable-object control system that can be installed in the movable apparatus that executes the above-described procedure.

Note that, in the following, a vehicle in which the vehicle control system 100 is installed is referred to as an own car or an own vehicle, thereby being distinguished from another vehicle.

The vehicle control system 100 includes an input unit 101, a data acquisition unit 102, a communication unit 103, a vehicle interior device 104, an output control unit 105, an output unit 106, a driving-system control unit 107, a driving system 108, a body-system control unit 109, a body system 110, a storage unit 111, and a self-driving control unit 112. The input unit 101, the data acquisition unit 102, the communication unit 103, the output control unit 105, the driving-system control unit 107, the body-system control unit 109, the storage unit 111, and the self-driving control unit 112 are connected to each other via a communication network 121. As examples of the communication network 121, there may be mentioned an on-vehicle communication network and a bus conforming to an arbitrary standard such as a CAN (Controller Area Network), a LIN (Local Interconnect Network), a LAN (Local Area Network), and FlexRay (registered trademark). Note that, the units of the vehicle control system 100 may be directly connected to each other not via the communication network 121.

Note that, in the following, description of the communication network 121 in cases where the units of the vehicle control system 100 perform communication via the communication network 121 is omitted. For example, a case where the input unit 101 and the self-driving control unit 112 perform communication via the communication network 121 is described simply as “the input unit 101 and the self-driving control unit 112 perform communication with each other.”

The input unit 101 includes an apparatus that enables a passenger to input various kinds of data items, instructions, and the like. For example, the input unit 101 includes operation devices such as a touchscreen, a button, a microphone, a switch, and a lever, and operation devices that can be operated by methods other than the manual operation, such as voice and gesture. Further, for example, the input unit 101 may be remote control apparatuses that utilize infrared rays or other radio waves, or external connection devices such as a mobile device and a wearable device, which supports the operation of the vehicle control system 100. The input unit 101 generates an input signal on the basis of the data items or the instructions input by the passenger, and supplies the input signal to the units of the vehicle control system 100.

The data acquisition unit 102 includes various sensors that acquire data items to be used for processes to be executed in the vehicle control system 100, and supplies the acquired data items to the units of the vehicle control system 100.

For example, the data acquisition unit 102 includes various sensors that detect a condition of the own vehicle, and the like. Specifically, for example, the data acquisition unit 102 includes a gyroscopic sensor, an acceleration sensor, an inertial measurement unit (IMU), and sensors that detect, for example, an operational amount of an accelerator pedal, an operational amount of a brake pedal, a steering angle of a steering wheel, an engine r.p.m., a motor r.p.m., and a wheel rotation speed.

Further, for example, the data acquisition unit 102 includes various sensors that detect information items outside the own vehicle. Specifically, for example, the data acquisition unit 102 includes imaging apparatuses such as a ToF (Time Of Flight) camera, a stereo camera, a monocular camera, an infrared camera, and other cameras. Further, for example, the data acquisition unit 102 includes an environment sensor that detects weather, a meteorological phenomenon, or the like, and an ambient-information detection sensor that detects an object in a vicinity of the own vehicle. As examples of the environment sensor, there may be mentioned a raindrop sensor, a fog sensor, a sunshine sensor, and a snow sensor. As examples of the ambient-information detection sensor, there may be mentioned an ultrasonic sensor, a radar, LiDAR (Light Detection and Ranging, Laser Imaging Detection and Ranging), and sonar.

Further, for example, the data acquisition unit 102 includes various sensors that detect a current position of the own vehicle. Specifically, for example, the data acquisition unit 102 includes a GNSS receiver that receives a GNSS signal from a GNSS (Global Navigation Satellite System) satellite.

Further, for example, the data acquisition unit 102 includes various sensors that detect vehicle-interior information items. Specifically, for example, the data acquisition unit 102 includes an imaging apparatus that captures an image of a driver, a biological sensor that detects biological information items of the driver, and a microphone that collects sound in a cabin of the vehicle. The biological sensor is provided, for example, on a seating surface or the steering wheel, and detects biological information items of the passenger sitting on a seat, or the biological information items of the driver holding the steering wheel.

Further, the data acquisition unit 102 acquires data items from the storage unit, and supplies these data items to the units of the vehicle control system 100. For example, the data acquisition unit 102 acquires vehicle-body structure data items of the own vehicle from the storage unit, and provides these data items, for example, to a self-position estimation unit.

The communication unit 103 communicates, for example, with the vehicle interior device 104, and various devices, a server, and a base station outside the vehicle so as to transmit data items supplied from the units of the vehicle control system 100, or to supply the received data items to the units of the vehicle control system 100. Note that, a communication protocol that the communication unit 103 supports is not particularly limited, and the communication unit 103 may support communication protocols of a plurality of types.

For example, the communication unit 103 performs wireless communication with the vehicle interior device 104 via a wireless LAN, Bluetooth (registered trademark), NFC (Near Field Communication), WUSB (Wireless USB), or the like. Further, for example, the communication unit 103 performs wired communication with the vehicle interior device 104 by USB (Universal Serial Bus), HDMI (registered trademark) (High-Definition Multimedia Interface), MHL (Mobile High-definition Link), or the like via a connection terminal (not shown) (and, when necessary, via cable).

Further, for example, the communication unit 103 communicates with devices (such as an application server and a control server) on external networks (such as the Internet, a cloud network, or a network unique to an operator) via a base station or an access point. Further, for example, the communication unit 103 communicates with terminals (such as a terminal of a pedestrian or a shop, and an MTC (Machine Type Communication) terminal) in the vicinity of the own vehicle by using a P2P (Peer To Peer) technology. Further, for example, the communication unit 103 performs V2X communication such as vehicle-to-vehicle communication, vehicle-to-infrastructure communication, communication between the own vehicle and a house, and vehicle-to-pedestrian communication. Further, for example, the communication unit 103 includes a beacon reception unit so as to receive radio wave or electromagnetic waves transmitted, for example, from a radio station installed on a road, and to acquire information items of, for example, the current position, traffic congestion, traffic regulation, or necessary time.

As examples of the vehicle interior device 104, there may be mentioned a mobile device or a wearable device that the passenger owns, an information device that is carried in or attached to the own vehicle, and a navigation apparatus that searches for a path to an arbitrary destination.

The output control unit 105 controls output of information items of various types to the passenger of the own vehicle or to the outside of the own vehicle. For example, the output control unit 105 generates an output signal containing at least one of a visual information item (such as image data item) and an auditory information item (such as audio data item), and supplies the signal to the output unit 106, thereby controlling output of the visual information item and the auditory information item from the output unit 106. Specifically, for example, the output control unit 105 fuses data items of images captured by different imaging apparatuses of the data acquisition unit 102 to generate an overhead image, a panoramic image, or the like, and supplies an output signal containing the generated image to the output unit 106. Further, for example, the output control unit 105 generates an audio data item containing warning sound, a warning message, or the like for danger such as collision, contact, and entry into a dangerous zone, and supplies an output signal containing the generated audio data item to the output unit 106.

The output unit 106 includes an apparatus capable of outputting the visual information item or the auditory information item to the passenger of the own vehicle or the outside of the own vehicle. For example, the output unit 106 includes a display apparatus, an instrument panel, an audio speaker, a headphone, wearable devices such as a spectacle-type display, which the passenger wears, a projector, and a lamp. The display apparatus of the output unit 106 is not limited to apparatuses including a normal display, and may be, for example, apparatuses that display visual information items within the field of view of the driver, such as a head-up display, a transmissive display, and an apparatus having an AR (Augmented Reality) display function.

The driving-system control unit 107 generates various control signals, and supplies the signals to the driving system 108, thereby controlling the driving system 108. Further, the driving-system control unit 107 supplies the control signals to the units other than the driving system 108 when necessary so as to, for example, notify of a control state of the driving system 108.

The driving system 108 includes various apparatuses related to the driving system of the own vehicle. For example, the driving system 108 includes driving-force generation apparatuses that generate a driving force, such as an internal combustion engine and a driving motor, a driving-force transmission mechanism that transmits the driving force to wheels, a steering mechanism that adjusts the steering angle, a braking apparatus that generates a braking force, an ABS (Antilock Brake System), an ESC (Electronic Stability Control), an electric power-steering apparatus.

The body-system control unit 109 generates various control signals, and supplies the signals to the body system 110, thereby controlling the body system 110. Further, the body-system control unit 109 supplies the control signals to the units other than the body system 110 when necessary so as to, for example, notify of a control state of the body system 110.

The body system 110 includes various body-system apparatuses with which the vehicle body is equipped. For example, the body system 110 includes a keyless entry system, a smart key system, a power window apparatus, a power seat, a steering wheel, an air conditioner, and various lamps (such as a head lamp, a back lamp, a brake lamp, a blinker, and a fog lamp).

The storage unit 111 includes a magnetic storage device such as a ROM (Read Only Memory), a RAM (Random Access Memory), and an HDD (Hard Disc Drive), a semiconductor storage device, an optical storage device, and a magneto-optical storage device. The storage unit 111 stores, for example, various programs and data items that the units of the vehicle control system 100 use. Specifically, the storage unit 111 stores map data items of a three-dimensional high precision map such as a dynamic map, a global map that has a lower precision and adapts to a wider area than the high precision map, and a local map containing information items of surroundings of the own vehicle.

The storage unit 111 also stores, for example, the vehicle-body structure data items of the own vehicle, and relative positions of an origin of the own vehicle with respect to the sensors.

The self-driving control unit 112 performs control on self-driving such as autonomous driving and driving assistance. Specifically, for example, the self-driving control unit 112 is capable of performing coordinated control for the purpose of realizing the ADAS (Advanced Driver Assistance System) function including avoiding collision of the own vehicle, lowering impacts of the vehicle collision, follow-up driving based on a distance between vehicles, constant speed driving, a collision warning for the own vehicle, and a lane departure warning for the own vehicle. Further, for example, the self-driving control unit 112 performs coordinated control for the purpose of realizing self-driving, that is, autonomous driving without a need of drivers' operations. The self-driving control unit 112 includes a detection unit 131, a self-position estimation unit 132, a situation analysis unit 133, a planning unit 134, and an operation control unit 135.

The detection unit 131 detects various types of information items necessary for control of the self-driving. The detection unit 131 includes a vehicle-exterior-information detection unit 141, a vehicle-interior-information detection unit 142, and a vehicle-state detection unit 143.

The vehicle-exterior-information detection unit 141 executes a process of detecting the information items outside the own vehicle on the basis of the data items or the signals from the units of the vehicle control system 100. For example, the vehicle-exterior-information detection unit 141 executes processes of detecting, recognizing, and following-up an object in the vicinity of the own vehicle, and a process of detecting a distance to the object. As examples of the object to be detected, there may be mentioned a vehicle, a human, an obstacle, a structure, a road, a traffic signal, a traffic sign, and a road sign. Further, for example, the vehicle-exterior-information detection unit 141 executes a process of detecting the ambient environment of the own vehicle. As examples of the ambient environment to be detected, there may be mentioned weather, temperature, humidity, brightness, and conditions of a road surface. The vehicle-exterior-information detection unit 141 supplies data items indicating results of the detection processes, for example, to the self-position estimation unit 132, a map analysis unit 151, a traffic-rule recognition unit 152, and a situation recognition unit 153 of the situation analysis unit 133, and an emergency-event avoidance unit 171 of the operation control unit 135.

The vehicle-interior-information detection unit 142 executes a process of detecting vehicle-interior information items on the basis of the data items or the signals from the units of the vehicle control system 100. For example, the vehicle-interior-information detection unit 142 executes processes of authenticating and recognizing the driver, a process of detecting the state of the driver, a process of detecting the passenger, and a process of detecting the environment inside the vehicle. As examples of the state of the driver to be detected, there may be mentioned a physical condition, an arousal degree, a concentration degree, a fatigue degree, and a line-of-sight direction. As examples of the environment inside the vehicle to be detected, there may be mentioned temperature, humidity, brightness, and smell. The vehicle-interior-information detection unit 142 supplies data items indicating results of the detection processes, for example, to the situation recognition unit 153 of the situation analysis unit 133, and the emergency-event avoidance unit 171 of the operation control unit 135.

The vehicle-state detection unit 143 executes a process of detecting the state of own vehicle on the basis of the data items or the signals from the units of the vehicle control system 100. As examples of the state of the own vehicle to be detected, there may be mentioned a speed, acceleration, a steering angle, presence/absence and content of abnormality, a state of a driving operation, a position and an inclination of the power seat, a state of a door lock, and states of other on-vehicle devices. The vehicle-state detection unit 143 supplies data items indicating results of the detection process, for example, to the self-position estimation unit 132, the situation recognition unit 153 of the situation analysis unit 133, and the emergency-event avoidance unit 171 of the operation control unit 135.

The self-position estimation unit 132 estimates a self-position of the own vehicle. The self-position refers to a position and a posture of the own vehicle in a three-dimensional space. The self-position estimation unit 132 includes a self-position calculation unit 181 and a self-position integration unit 183.

The self-position calculation unit 181 executes a process of estimating, for example, the position and the posture of the own vehicle on the basis of the data items or the signals from the units of the vehicle control system 100, such as the vehicle-state detection unit 143, the vehicle-exterior-information detection unit 141, and the situation recognition unit 153 of the situation analysis unit 133. The self-position calculation unit 181 includes one or more self-position calculators 182.

The self-position calculators 182 are each capable of executing the process of estimating, for example, the position and the posture of the own vehicle on the basis of the data items or the signals from the units of the vehicle control system 100, such as the vehicle-state detection unit 143, the vehicle-exterior-information detection unit 141, and the situation recognition unit 153 of the situation analysis unit 133.

The self-positions that the self-position calculators 182 output are referred to as calculator self-positions. The self-position calculators utilize, for example, a technology of estimating the position and the posture of the own vehicle from a GNSS signal and an IMU, a SLAM (Simultaneous Localization and Mapping) technology, an odometry (wheel odometry) technology of estimating the position and the posture of the own vehicle from a wheel r.p.m and the steering angle, and a self-position identification technology NDT (normal distributions transform) including matching observation results from LiDAR and a high-precision three-dimensional map.

The number of the self-position calculators that properly operate may increase or decrease depending on types of the data items or the signals from the vehicle-exterior-information detection unit, the vehicle-state detection unit, or the situation recognition unit at a design phase or at a time of activation or execution. For example, whether the NDT can properly operate depends on whether input from the LiDAR can be acquired.

Further, the self-position calculators 182 each generates, when necessary, a local map (hereinafter, referred to as self-position estimation map) to be used for estimating the self-position. The self-position estimation map is, for example, a high precision map using the technologies such as the SLAM. Further, the self-position calculators 182 cause the storage unit 111 to store the self-position estimation maps.

The self-position integration unit 183 outputs a self-position as a result of integration of the calculator self-positions from the one or more self-position calculators by an integration method. The self-position that the self-position integration unit outputs is referred to as an integrated self-position.

The self-position integration unit 183 receives environment information items from the situation analysis unit 133. For example, the self-position integration unit 183 receives environment information items of situations outside the movable apparatus, such as brightness and field of vision, and environment information items of operating conditions of the sensors, conditions whether or not failures have occurred, and utilization conditions of resources, and applies an integration method determined on the basis of these environment information items, thereby calculating the one self-position.

The integration method refers to a method of calculating the integrated self-position by integrating the self-positions that the plurality of self-position calculators have calculated. As described above in detail with reference to FIG. 17 and FIG. 18, examples of the integration method include the process of selecting, depending on conditions, the standard self-position calculated on the basis of a self-position that one of the self-position calculators has calculated, and the process of fusing the standard self-positions calculated on the basis of self-positions that the plurality of self-position calculators have calculated.

The self-position integration unit 183 supplies a data item indicating an integrated self-position, for example, to the map analysis unit 151, the traffic-rule recognition unit 152, and the situation recognition unit 153 of the situation analysis unit 133.

The situation analysis unit 133 executes a process of analyzing situations of the own vehicle and the surroundings thereof. The situation analysis unit 133 includes the map analysis unit 151, the traffic-rule recognition unit 152, the situation recognition unit 153, and a situation prediction unit 154.

The map analysis unit 151 executes a process of analyzing the various maps stored in the storage unit 111 while using the data items or the signals from the units of the vehicle control system 100, such as the self-position estimation unit 132 and the vehicle-exterior-information detection unit 141 when necessary, thereby building a map containing information items necessary for self-driving processes. The map analysis unit 151 supplies the built map, for example, not only to the traffic-rule recognition unit 152, the situation recognition unit 153, and the situation prediction unit 154, but also to a route planning unit 161, an action planning unit 162, and an operation planning unit 163 of the planning unit 134.

The traffic-rule recognition unit 152 executes a process of recognizing a traffic rule in the vicinity of the own vehicle on the basis of the data items or the signals from the units of the vehicle control system 100, such as the self-position estimation unit 132, the vehicle-exterior-information detection unit 141, and the map analysis unit 151. By this recognition process, for example, a position and a state of a traffic signal in the vicinity of the own vehicle, content of the traffic regulation in the vicinity of the own vehicle, and a drivable lane are recognized. The traffic-rule recognition unit 152 supplies data items indicating results of the recognition process, for example, to the situation prediction unit 154.

The situation recognition unit 153 executes a process of recognizing the situation regarding the own vehicle on the basis of the data items or the signals from the units of the vehicle control system 100, such as the self-position estimation unit 132, the vehicle-exterior-information detection unit 141, the vehicle-interior-information detection unit 142, the vehicle-state detection unit 143, and the map analysis unit 151. For example, the situation recognition unit 153 executes a process of recognizing the situation of the own vehicle, the situation of the surroundings of the own vehicle, the state of the driver of the own vehicle, and the like. Further, when necessary, the situation recognition unit 153 generates a local map (hereinafter, referred to as situation recognition map) to be used for recognizing the situation of the surroundings of the own vehicle. The situation recognition map is, for example, an occupancy grid map.

Examples of the situation of the own vehicle to be recognized include the position, the posture, and movement (specifically, a speed, acceleration, and a moving direction) of the own vehicle, and presence/absence of and content of abnormality. Examples of the situation of the surroundings of the own vehicle to be recognized includes a type and a position of a stationary object of the surroundings, a type, a position, and movement (specifically, a speed, acceleration, and a moving direction) of a movable body of the surroundings, a configuration of the road of the surroundings, the conditions of the road surface, weather, temperature, humidity, and brightness of the surroundings. Examples of the state of the driver to be recognized includes the physical condition, the arousal degree, the concentration degree, the fatigue degree, movement of the line of sight, and the driving operation.

The situation recognition unit 153 supplies data items (containing the situation recognition map when necessary) indicating results of the recognition process, for example, to the self-position estimation unit 132 and the situation prediction unit 154, for example. Further, the situation recognition unit 153 causes the storage unit 111 to store the situation recognition map.

The situation prediction unit 154 executes a process of predicting the situation regarding the own vehicle on the basis of the data items or the signals from the units of the vehicle control system 100, such as the map analysis unit 151, the traffic-rule recognition unit 152, and the situation recognition unit 153. For example, the situation prediction unit 154 executes a process of predicting the situation of the own vehicle, the situation of the surroundings of the own vehicle, and the state of the driver.

As examples of the situation of the own vehicle to be predicted, there may be mentioned behavior of the own vehicle, occurrence of abnormality, and a driving range. As examples of the situation of the surroundings of the own vehicle to be predicted, there may be mentioned behavior of the movable body in the vicinity of the own vehicle, a change of the state of the traffic signal, and change of the environment such as weather. Examples of the state of the driver to be predicted include the behavior and the physical condition of the driver.

The situation prediction unit 154 supplies data items indicating results of the prediction process, for example, to the route planning unit 161, the action planning unit 162, and the operation planning unit 163 of the planning unit 134 together with the data items from the traffic-rule recognition unit 152 and the situation recognition unit 153.

The route planning unit 161 plans a route to a destination on the basis of the data items or the signals from the units of the vehicle control system 100, such as the map analysis unit 151 and the situation prediction unit 154. For example, the route planning unit 161 sets a route from a current position to a specified destination on the basis of the global map. Further, for example, the route planning unit 161 changes the route as appropriate on the basis of the traffic congestion, the accident, the traffic regulation, conditions of construction or the like, the physical condition of the driver, and the like. The route planning unit 161 supplies data items indicating the planned route, for example, to the action planning unit 162.

The action planning unit 162 plans an action of the own vehicle for safely driving on the route planned by the route planning unit 161 within a planned time period on the basis of the data items or the signals from the units of the vehicle control system 100, such as the map analysis unit 151 and the situation prediction unit 154. For example, the action planning unit 162 develops plans for starting, stopping, travelling directions (such as forward, backward, turning left, turning right, and changing direction), a driving lane, a driving speed, overtaking, and the like. The action planning unit 162 supplies data items indicating the planned action of the own vehicle, for example, to the operation planning unit 163.

The operation planning unit 163 plans an operation of the own vehicle for carrying out the action planned by the action planning unit 162 on the basis of the data items or the signals from the units of the vehicle control system 100, such as the map analysis unit 151 and the situation prediction unit 154. For example, the operation planning unit 163 develops plans for acceleration, deceleration, running track, and the like. The operation planning unit 163 supplies data items indicating the planned operation of the own vehicle, for example, to an acceleration/deceleration control unit 172 and a direction control unit 173 of the operation control unit 135.

The operation control unit 135 controls the operation of the own vehicle. The operation control unit 135 includes the emergency-event avoidance unit 171, the acceleration/deceleration control unit 172, and the direction control unit 173.

The emergency-event avoidance unit 171 executes a process of detecting emergency events such as the collision, the contact, the entry into a dangerous zone, abnormality of the driver, and the abnormality of the own vehicle on the basis of the results of the detection by the vehicle-exterior-information detection unit 141, the vehicle-interior-information detection unit 142, and the vehicle-state detection unit 143. In case of detecting occurrence of the emergency event, the emergency-event avoidance unit 171 plans operations (such as sudden stop and sudden turn) of the own vehicle for avoiding the emergency event. The emergency-event avoidance unit 171 supplies data items indicating the planned operation of the own vehicle, for example, to the acceleration/deceleration control unit 172 and the direction control unit 173.

The acceleration/deceleration control unit 172 performs acceleration/deceleration control for performing the operation of the own vehicle, which is planned by the operation planning unit 163 or the emergency-event avoidance unit 171. For example, the acceleration/deceleration control unit 172 calculates a control target value of the driving-force generation apparatus or the braking apparatus for carrying out the planned acceleration, the planned deceleration, or the planned sudden stop, and supplies a control command indicating the calculated control-target value to the driving-system control unit 107.

The direction control unit 173 controls the direction for performing the operation of the own vehicle, which is planned by the operation planning unit 163 or the emergency-event avoidance unit 171. For example, the direction control unit 173 calculates a control target value of the steering mechanism for running on the running track or carrying out the sudden turn planned by the operation planning unit 163 or the emergency-event avoidance unit 171, and supplies a control command indicating the calculated control-target value to the driving-system control unit 107.

(6. Configuration Example of Information Processing Apparatus)

FIG. 21 shows a configuration example of the vehicle control system 100 as an example of a movable-object control system that can be installed in the movable apparatus that executes the above-described processes. The processes according to the above description in this embodiment may be executed, for example, by inputting information items, which the various sensors corresponding to the plurality of self-position calculators, such as a camera, have detected, to information processing apparatuses such as a PC, executing processes on these data items, generating the information item of updating the relative-position tree, and updating the relative-position tree stored in the storage unit in the information processing apparatus.

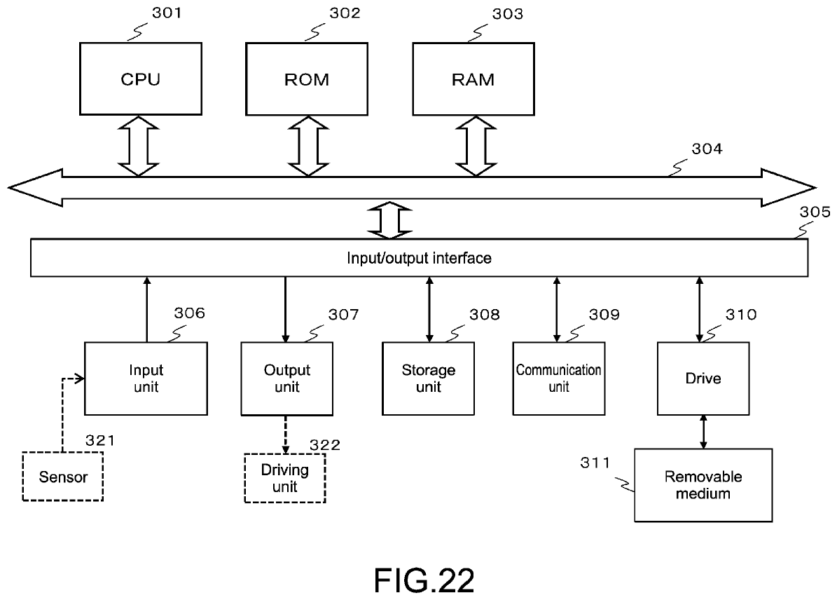

A specific configuration example of hardware of the information processing apparatus in this case is described with reference to FIG. 22.

FIG. 22 is a diagram showing the configuration example of the hardware of the information processing apparatus such as a general PC.

A CPU (Central Processing Unit) 301 functions as a data processing unit that executes various processes in accordance with programs stored in a ROM (Read Only Memory) 302 or a storage unit 308. For example, the CPU 301 executes the processes based on the sequences described above in this embodiment. A RAM (Random Access Memory) 303 stores, for example, the programs that the CPU 301 executes and data items. The CPU 301, the ROM 302, and the RAM 303 are connected to each other via a bus 304.

The CPU 301 is connected to an input/output interface 305 via the bus 304. To the input/output interface 305, an input unit 306 including not only various switches, a keyboard, a touchscreen, a mouse, and a microphone, but also situation-data acquisition units such as a sensor, a camera, and a GPS, and an output unit 307 including a display and a speaker are connected.

Note that, the input unit 306 receives input information items from a sensor 321.

Further, the output unit 307 outputs driving information items with respect to a driving unit 322 of the movable apparatus.

The CPU 301 receives, for example, commands and situation data items that are input via the input unit 306, executes the various processes, and outputs results of the processes, for example, to the output unit 307.

The storage unit 308, which is connected to the input/output interface 305, stores the programs that the CPU 301 executes and the various data items. The storage unit 308 is, for example, a hard disk. A communication unit 309 functions as a transmitting/receiving unit for data communication via networks such as the Internet and a local area network, and communicates with external apparatuses.

A drive 310, which is connected to the input/output interface 305, drives removable media 311 such as a magnetic disk, an optical disk, a magneto-optical disk, and semiconductor memories such as a memory card. The drive 310 records or reads out data items.

(7. Summary of Configuration According to Embodiment of Present Disclosure)

Hereinabove, the present disclosure has been described in detail with reference to a specific embodiment. However, as a matter of course, those skilled in the art may make modifications and alterations of the embodiment without departing from the gist of the present disclosure. In other words, the present disclosure has been described hereinabove merely as an example, and hence should not be construed restrictively. The gist of the present disclosure should be determined with reference to the appended claims.

Note that, the technology disclosed herein may also provide the following configurations.

(1) An information processing apparatus, including:

a plurality of self-position calculators configured to calculate a plurality of self-positions; and

a self-position integration unit configured to integrate the plurality of calculated self-positions that the plurality of self-position calculators have calculated to calculate one final self-position,

the self-position integration unit

converting, in consideration of sensor positions of sensors that the plurality of self-position calculators utilize, the plurality of calculated self-positions calculated by the plurality of self-position calculators and corresponding to the plurality of self-position calculators to a plurality of standard self-positions, and

calculating the one final self-position by utilizing the plurality of standard self-positions being conversion results.

(2) The information processing apparatus according to Item (1), in which

the self-position integration unit determines, on the basis of environment information items, a pattern for calculating the one final self-position from the plurality of standard self-positions.

(3) The information processing apparatus according to Item (2), in which

the environment information items include at least any of

an information item of an external environment of a movable apparatus that moves along a movement path to be determined by application of the one final self-position,

information items of failures of the sensors that the plurality of self-position calculators utilize, and

an information item of a utilization condition of a resource.

(4) The information processing apparatus according to any one of Items (1) to (3), in which

the self-position integration unit selects, on the basis of environment information items, one standard self-position from among the plurality of standard self-positions corresponding to the plurality of self-position calculators, and determines the one selected standard self-position as the one final self-position.

(5) The information processing apparatus according to any one of Items (1) to (4), in which

the self-position integration unit calculates, on the basis of environment information items, one fused standard self-position by fusing the plurality of standard self-positions corresponding to the plurality of self-position calculators, and determines the calculated one fused standard self-position as the one final self-position.

(6) The information processing apparatus according to any one of Item (1) to (5), in which

the self-position integration unit

determines one selected standard self-position by selecting, on the basis of environment information items, one standard self-position from among the plurality of standard self-positions corresponding to the plurality of self-position calculators,

calculates, on the basis of the environment information items, one fused standard self-position by fusing the plurality of standard self-positions corresponding to the plurality of self-position calculators,

switches, on the basis of the environment information items, the one selected standard self-position and the one fused standard self-position to each other, and

determines, as the one final self-position, one of the one selected standard self-position and the one fused standard self-position.

(7) The information processing apparatus according to any one of Items (1) to (6), further including

a storage unit configured to store a relative-position tree that records

a plurality of differently-defined coordinate origins, or

relative positions of nodes corresponding to object positions, in which

the self-position integration unit calculates the one final self-position as an information item of updating the relative-position tree.

(8) The information processing apparatus according to Item (7), in which

the relative-position tree includes

a plurality of self-position-calculator-corresponding sensor nodes having information items of the sensor positions corresponding to the plurality of self-position calculators that move along with movement of a movable apparatus to which the plurality of self-position calculators are attached, and

a plurality of self-position-calculator origin nodes each having an information item of a position that does not move along with the movement of the movable apparatus, and

relative positions of the plurality of self-position-calculator-corresponding sensor nodes and the plurality of self-position-calculator origin nodes as link data items.

(9) The information processing apparatus according to Item (8), in which

the relative-position tree further includes one apparatus-origin node indicating an apparatus origin position of the movable apparatus, and

the plurality of self-position-calculator-corresponding sensor nodes corresponding respectively to the plurality of self-position calculators are connected to the one apparatus origin node with links that indicate relative positions of the plurality of self-position-calculator-corresponding sensor nodes with respect to the one apparatus-origin node.

(10) The information processing apparatus according to Item (9), in which

the self-position integration unit calculates the one final self-position as an information item of updating the apparatus origin position contained in the relative-position tree.

(11) A movable apparatus, including:

a plurality of self-position calculators configured to calculate a plurality of self-positions;

a self-position integration unit configured to integrate the plurality of calculated self-positions that the plurality of self-position calculators have calculated to calculate one final self-position;

a planning unit configured to determine an action of the movable apparatus by utilizing the one final self-position that the self-position integration unit has calculated; and

an operation control unit configured to control an operation of the movable apparatus on the basis of the action that the planning unit has determined,

the self-position integration unit

converting, in consideration of sensor positions of sensors that the plurality of self-position calculators utilize, the plurality of calculated self-positions calculated by the plurality of self-position calculators and corresponding to the plurality of self-position calculators to a plurality of standard self-positions, and

calculating the one final self-position by utilizing the plurality of standard self-positions being conversion results.

(12) The movable apparatus according to Item (11), in which

the self-position integration unit determines, on the basis of environment information items, a pattern for calculating the one final self-position from the plurality of standard self-positions.

(13) The movable apparatus according to Item (12), in which

the environment information items include at least any of

an information item of an external environment of the movable apparatus that moves along a movement path to be determined by application of the one final self-position,

information items of failures of the sensors that the plurality of self-position calculators utilize, and

an information item of a utilization condition of a resource.

(14) The movable apparatus according to any one of Items (11) to (13), in which

the self-position integration unit determines, on the basis of environment information items, as the one final self-position, either one of

one selected standard self-position selected from among the plurality of standard self-positions corresponding to the plurality of self-position calculators, and

one fused standard self-position calculated by fusing the plurality of standard self-positions corresponding to the plurality of self-position calculators.

(15) The movable apparatus according to any one of Items (11) to (14), further including

a storage unit configured to store a relative-position tree that records

a plurality of differently-defined coordinate origins, or

relative positions of nodes corresponding to object positions, in which

the self-position integration unit calculates the one final self-position as an information item of updating the relative-position tree.

(16) The movable apparatus according to Item (15), in which the relative-position tree includes

a plurality of self-position-calculator-corresponding sensor nodes having information items of the sensor positions corresponding to the plurality of self-position calculators that move along with movement of a movable apparatus to which the plurality of self-position calculators are attached, and

a plurality of self-position-calculator origin nodes each having an information item of a position that does not move along with the movement of the movable apparatus, and

relative positions of the plurality of self-position-calculator-corresponding sensor nodes and the plurality of self-position-calculator origin nodes as link data items.

(17) An information processing method that an information processing apparatus carries out, the information processing method including:

respectively calculating, by a plurality of self-position calculators, a plurality of self-positions; and

integrating, by a self-position integration unit, the plurality of calculated self-positions that the plurality of self-position calculators have calculated to calculate one final self-position,

the integrating including

converting, in consideration of sensor positions of sensors that the plurality of self-position calculators utilize, the plurality of calculated self-positions calculated by the plurality of self-position calculators and corresponding to the plurality of self-position calculators to a plurality of standard self-positions, and

calculating the one final self-position by utilizing the plurality of standard self-positions being conversion results.

(18) A movable-apparatus control method that a movable apparatus carries out, the movable-apparatus control method including:

respectively calculating, by a plurality of self-position calculators, a plurality of self-positions;

integrating, by a self-position integration unit, the plurality of calculated self-positions that the plurality of self-position calculators have calculated to calculate one final self-position;

determining, by a planning unit, an action of the movable apparatus by utilizing the one final self-position that the self-position integration unit has calculated; and

controlling, by an operation control unit, an operation of the movable apparatus on the basis of the action that the planning unit has determined,

the integrating including

converting, in consideration of sensor positions of sensors that the plurality of self-position calculators utilize, the plurality of calculated self-positions calculated by the plurality of self-position calculators and corresponding to the plurality of self-position calculators to a plurality of standard self-positions, and

calculating the one final self-position by utilizing the plurality of standard self-positions being conversion results.

(19) A program that causes an information processing apparatus to execute information processes including the steps of:

respectively calculating, by a plurality of self-position calculators, a plurality of self-positions; and

integrating, by a self-position integration unit, the plurality of calculated self-positions that the plurality of self-position calculators have calculated to calculate one final self-position,

the integrating including

converting, in consideration of sensor positions of sensors that the plurality of self-position calculators utilize, the plurality of calculated self-positions calculated by the plurality of self-position calculators and corresponding to the plurality of self-position calculators to a plurality of standard self-positions, and

calculating the one final self-position by utilizing the plurality of standard self-positions being conversion results.

(20) A program that causes a movable apparatus to execute movable-apparatus control processes including the steps of:

respectively calculating, by a plurality of self-position calculators, a plurality of self-positions;

integrating, by a self-position integration unit, the plurality of calculated self-positions that the plurality of self-position calculators have calculated to calculate one final self-position;

determining, by a planning unit, an action of the movable apparatus by utilizing the one final self-position that the self-position integration unit has calculated; and

controlling, by an operation control unit, an operation of the movable apparatus on the basis of the action that the planning unit has determined,

the integrating including

converting, in consideration of sensor positions of sensors that the plurality of self-position calculators utilize, the plurality of calculated self-positions calculated by the plurality of self-position calculators and corresponding to the plurality of self-position calculators to a plurality of standard self-positions, and

calculating the one final self-position by utilizing the plurality of standard self-positions being conversion results.

(21)

An information processing apparatus, comprising:

a plurality of self-position calculators configured to calculate a plurality of self-positions; and

a self-position integrator configured to:

integrate the plurality of calculated self-positions to determine one final self-position, wherein integrating the plurality of calculated self-positions to determine one final self-position comprises:

converting, based on sensor positions of sensors that the plurality of self-position calculators utilize, the plurality of calculated self-positions to a plurality of standard self-positions; and

determining the one final self-position based on the plurality of standard self-positions.

(22)

The information processing apparatus according to Item (21), wherein

the self-position integrator determines, based on one or more environment information items, a pattern for determining the one final self-position from the plurality of standard self-positions.

(23)

The information processing apparatus according to Item (22), wherein the one or more environment information items include at least one item selected from the group consisting of:

an external environment information item of the information processing apparatus that moves along a movement path to be determined, at least in part, based on of the one final self-position,

a failure information item indicating failure of one or more of the sensors that the plurality of self-position calculators utilize, and

a utilization information item indicating a utilization condition of a computational resource.

(24)

The information processing apparatus according to Item (21), wherein the self-position integrator is configured to:

select, based on one or more environment information items, one standard self-position from among the plurality of standard self-positions; and

determine the one selected standard self-position to be the one final self-position.

(25)

The information processing apparatus according to Item (21), wherein the self-position integrator is configured to:

determine, based on one or more environment information items, one fused standard self-position by fusing the plurality of standard self-positions; and

determine the determined one fused standard self-position to be the one final self-position.

(26)

The information processing apparatus according to Item (21), wherein the self-position integrator is configured to:

determine one selected standard self-position by selecting, based on one or more environment information items, one standard self-position from among the plurality of standard self-positions;

determine, on the basis of the environment information items, one fused standard self-position by fusing the plurality of standard self-positions;

switch, based on the one or more environment information items, between the one selected standard self-position and the one fused standard self-position as the one final self-position.

(27)

The information processing apparatus according to Item (21), further comprising:

a storage device configured to store a relative-position tree that records:

a plurality of differently-defined coordinate origins; and

relative positions of the plurality of differently-defined coordinate origins and object positions, wherein

the self-position integrator is configured to determine the one final self-position based on the relative-position tree.

(28)

The information processing apparatus according to Item (27), wherein the relative-position tree includes:

a plurality of self-position-calculator-corresponding sensor nodes having sensor position information items indicating the sensor positions of the sensors, wherein the sensor positions that the plurality of self-position calculators utilize move along with movement of a movable the information processing apparatus;

a plurality of self-position-calculator origin nodes each having an origin information item indicating a position that does not move along with the movement of the information processing apparatus;

and

a plurality of link data items indicating relative positions of the plurality of self-position-calculator-corresponding sensor nodes and the plurality of self-position-calculator origin nodes.

(29)

The information processing apparatus according to Item (28), wherein:

the relative-position tree further includes one apparatus-origin node indicating an apparatus origin position of the information processing apparatus; and

the plurality of self-position-calculator-corresponding sensor nodes correspond respectively to the plurality of self-position calculators and are connected to the one apparatus origin node with links that indicate relative positions of the plurality of self-position-calculator-corresponding sensor nodes with respect to the one apparatus-origin node.

(30)

The information processing apparatus according to Item (29), wherein

the self-position integrator is configured to determine the one final self-position based on the apparatus origin position contained in the relative-position tree.

(31)

A movable apparatus, comprising:

a plurality of self-position calculators configured to calculate a plurality of self-positions;

a self-position integrator configured to integrate the plurality of calculated self-positions to determine one final self-position, wherein integrating the plurality of calculated self-positions to determine one final self-position comprises:

converting, based on sensor positions of sensors that the plurality of self-position calculators utilize, the plurality of calculated self-positions to a plurality of standard self-positions; and

determining the one final self-position based on the plurality of standard self-positions;

an action determiner configured to determine an action of the movable apparatus based on the one final self-position; and

an operation controller configured to control an operation of the movable apparatus on the basis of the action.

(32)

The movable apparatus according to Item (31), wherein

the self-position integrator determines, based on one or more environment information items, a pattern for determining the one final self-position from the plurality of standard self-positions.

(33)

The movable apparatus according to Item (32), wherein the one or more environment information items include at least one item selected from the group consisting of:

an external environment information item of the movable apparatus that moves along a movement path to be determined, at least in part, based on the one final self-position,

a failure information item indicating failure of one or more of the sensors that the plurality of self-position calculators utilize, and

a utilization information item indicating a utilization condition of a computational resource.

(34)

The movable apparatus according to Item (31), wherein the self-position integrator is configured to determine, based on one or more environment information items, as the one final self-position, either one of:

one selected standard self-position selected from among the plurality of standard self-positions, and

one fused standard self-position calculated by fusing the plurality of standard self-positions.

(35)

The movable apparatus according to Item (31), further comprising

a storage device configured to store a relative-position tree that records:

a plurality of differently-defined coordinate origins; and

relative positions of nodes corresponding to object positions, wherein

the self-position integrator is configured to determine the one final self-position based on the relative-position tree.

(36)

The movable apparatus according to Item (35), wherein the relative-position tree includes:

a plurality of self-position-calculator-corresponding sensor nodes having sensor position information items indicating the sensor positions of the sensors, wherein the sensor position that the plurality of self-position calculators utilize move along with movement of the movable apparatus, and

a plurality of self-position-calculator origin nodes each having an origin information item indicating a position that does not move along with the movement of the movable apparatus,

and

a plurality of link data items indicating relative positions of the plurality of self-position-calculator-corresponding sensor nodes and the plurality of self-position-calculator origin nodes.

(37)

An information processing method that an information processing apparatus performs, the information processing method comprising:

respectively calculating, by a plurality of self-position calculators, a plurality of self-positions; and

integrating, by a self-position integrator, the plurality of calculated self-positions to determine one final self-position,

the integrating including

converting, based on sensor positions of sensors that the plurality of self-position calculators utilize, the plurality of calculated self-positions to a plurality of standard self-positions, and

determining the one final self-position based on the plurality of standard self-positions.

(38)

A movable-apparatus control method that a movable apparatus carries out, the movable-apparatus control method comprising:

respectively calculating, by a plurality of self-position calculators, a plurality of self-positions;

integrating, by a self-position integrator, the plurality of calculated self-positions to determine one final self-position, the integrating including:

converting, based on sensor positions of sensors that the plurality of self-position calculators utilize, the plurality of calculated self-positions to a plurality of standard self-positions, and

determining the one final self-position based on the plurality of standard self-positions;

determining, by an action determiner, an action of the movable apparatus based on the one final self-position; and

controlling, by an operation controller, an operation of the movable apparatus on the basis of the action.

(39)

At least one non-transitory storage medium encoded with executable instructions that, when executed by at least one processor of an information processing apparatus, cause the at least one processor to carry out a method, wherein the method comprises:

calculating a plurality of self-positions; and

integrating the plurality of calculated self-positions to determine one final self-position, the integrating including:

converting, based on sensor positions of sensors that determine the plurality of self-positions, the plurality of calculated self-positions to a plurality of standard self-positions, and

determining the one final self-position based on the plurality of standard self-positions.

(40)

At least one non-transitory storage medium encoded with executable instructions that, when executed by at least one processor of a moveable apparatus, cause the at least one processor to carry out a method, wherein the method comprises:

calculating a plurality of self-positions;

integrating the plurality of calculated self-positions to determine one final self-position, the integrating including:

converting, based on sensor positions of sensors that the plurality of self-position calculators utilize, the plurality of calculated self-positions to a plurality of standard self-positions, and

determining the one final self-position based on the plurality of standard self-positions;

determining an action of the movable apparatus based on the one final self-position; and

controlling an operation of the movable apparatus based on the action.

Further, the series of processes described hereinabove can be executed by hardware, software, or a composite configuration of the hardware and the software. In order that the processes can be executed by the software, programs, which store a sequence of the processes and are installed in a memory in a computer incorporated in dedicated hardware, are executed. Alternatively, the programs to be executed may be installed in a general-purpose computer capable of executing various processes. For example, the programs may be recorded in advance in a recording medium, and then installed from the recording medium to the computer. Alternatively, the programs may be received via networks such as a LAN (Local Area Network) or the Internet, and then installed in recording media such as a built-in hard disk.

Note that, the various processes described hereinabove need not necessarily be executed in time series according to the description, and may be executed in accordance with processing capabilities of apparatuses that execute the processes, or in parallel or individually when necessary. Further, the “system” herein refers to a logical collective configuration of a plurality of apparatuses, and these apparatuses having respective configurations are not necessarily provided in the same casing.

### INDUSTRIAL APPLICABILITY

As described hereinabove, a configuration according to an embodiment of the present disclosure enables acquisition of one final apparatus-position information item based on a plurality of calculated self-positions that a plurality of self-position calculators configured to calculate a plurality of self-positions have calculated.

Specifically, for example, the configuration includes the plurality of self-position calculators configured to calculate the plurality of self-positions, and a self-position integration unit configured to integrate the plurality of calculated self-positions that the plurality of self-position calculators have calculated to calculate the one final self-position. The self-position integration unit converts, in consideration of positions of sensors of the plurality of self-position calculators, the plurality of calculated self-positions corresponding to the plurality of self-position calculators to a plurality of standard self-positions, and calculates the one final self-position from the plurality of standard self-positions. The self-position integration unit calculates the one final self-position on the basis of environment information items such as an information item of an external environment of a movable apparatus, information items of failures of the sensors that the plurality of self-position calculators utilize, and an information item of a utilization condition of a resource.

With this configuration, it is possible to acquire the one final apparatus-position information item on the basis of the plurality of calculated self-positions that the plurality of self-position calculators configured to calculate the plurality of calculated self-positions have calculated.

### REFERENCE SIGNS LIST

10 Movable apparatus
21 Map origin
22 Self-position origin
23 Apparatus origin
31, 32, 33 Self-position calculator
41, 42 Relative-position-tree update module
43 Storage unit
44, 45, 46 Relative-position-tree utilization module
47, 48 Relative-position-tree update module
51 Map origin
52 Self-position origin
53 Apparatus origin
54 Camera
55 Wheel center
56, 57 Relative-position-tree update module
71 Map origin
72 Self-position origin
73 Apparatus origin
74 Camera
75 Wheel center
76 Origin of self-position calculator P
77 Origin of self-position calculator Q
78, 79 Relative-position-tree update module
80 Self-position integration unit
82 Storage unit
83 Situation analysis unit
100 Vehicle control system
101 Input unit
102 Data acquisition unit
103 Communication unit
104 Vehicle interior device
105 Output control unit
106 Output unit
107 Driving-system control unit
108 Driving system
109 Body-system control unit
110 Body system
111 Storage unit
112 Self-driving control unit
121 Communication network
131 Detection unit
132 Self-position estimation unit
133 Situation analysis unit
134 Planning unit
135 Operation control unit
141 Vehicle-exterior-information detection unit
142 Vehicle-interior-information detection unit
143 Vehicle-state detection unit
151 Map analysis unit
152 Traffic-rule recognition unit
153 Situation recognition unit
154 Situation prediction unit
161 Route planning unit
162 Action planning unit
163 Operation planning unit
171 Emergency-event avoidance unit
172 Acceleration/deceleration control unit
173 Direction control unit
181 Self-position calculation unit
182 Self-position calculator
183 Self-position integration unit
301 CPU
302 ROM
303 RAM
304 Bus
305 Input/output interface
306 Input unit
307 Output unit
308 Storage unit
309 Communication unit
310 Drive
311 Removable medium
321 Sensor
322 Driving unit

1. An information processing apparatus, comprising:
a plurality of self-position calculators configured to calculate a plurality of self-positions, each self-position calculator using measurement information acquired by one or more sensors arranged in or at a movable apparatus to calculate its self-position representing the position of the respective self-position calculator; and
a self-position integration unit configured to integrate the plurality of calculated self-positions to one final self-position representing the position of the movable apparatus by calculating a plurality of standard self-positions by converting, in consideration of sensor positions of the one or more sensors, the plurality of calculated self-positions to the plurality of standard self-positions, a standard self-position representing the position of the movable apparatus determined by converting a calculated self-position, in consideration of the one or more sensor positions of the sensors utilized by the respective self-position calculator to calculate its self-position, to said standard self-position, and
calculating the one final self-position from the plurality of calculated standard self-positions.

2. The information processing apparatus according to claim 1, wherein
the self-position integration unit is configured to determine, on the basis of environment information items, a processing pattern for calculating the one final self-position from the plurality of calculated standard self-positions.

3. The information processing apparatus according to claim 2, wherein
the environment information items include at least any of an information item of an external environment of the movable apparatus that moves along a movement path to be determined by application of the one final self-position, information items of failures of the sensors, and an information item of a utilization condition of a resource.

4. The information processing apparatus according to claim 1, wherein
the self-position integration unit is configured to select, on the basis of environment information items, one standard self-position from among the plurality of calculated standard self-positions, and to determine the one selected standard self-position as the one final self-position.

5. The information processing apparatus according to claim 1, wherein
the self-position integration unit is configured to calculate, on the basis of environment information items, one fused standard self-position by fusing the plurality of calculated standard self-positions, and determine the calculated one fused standard self-position as the one final self-position.

6. The information processing apparatus according to claim 1, wherein the self-position integration unit is configured to:
determine one selected standard self-position by selecting, on the basis of environment information items, one standard self-position from among the plurality of calculated standard self-positions,
calculate, on the basis of the environment information items, one fused standard self-position by fusing the plurality of calculated standard self-positions;
switch, on the basis of the environment information items, the one selected standard self-position and the one fused standard self-position to each other, and
determine, as the one final self-position, one of the one selected standard self-position and the one fused standard self-position.

7. The information processing apparatus according to claim 1, further comprising:
a storage unit configured to store a relative-position tree that records:
a plurality of differently-defined coordinate origins, and
relative positions of the plurality of differently-defined coordinate origins and object positions, wherein
the self-position integration unit is configured to calculate the one final self-position as an information item of updating the relative-position tree.

8. The information processing apparatus according to claim 7, wherein
the relative-position tree includes:
a plurality of self-position-calculator-corresponding sensor nodes having information items of the sensor positions corresponding to the plurality of self-position calculators that move along with movement of the movable apparatus, and
a plurality of self-position-calculator origin nodes each having an information item of a position that does not move along with the movement of the movable apparatus, and
relative positions of the plurality of self-position-calculator-corresponding sensor nodes and the plurality of self-position-calculator origin nodes as link data items.

9. The information processing apparatus according to claim 8, wherein:
the relative-position tree further includes one apparatus-origin node indicating an apparatus origin position of the movable apparatus, and
the plurality of self-position-calculator-corresponding sensor nodes corresponding respectively to the plurality of self-position calculators are connected to the one apparatus origin node with links that indicate relative positions of the plurality of self-position-calculator-corresponding sensor nodes with respect to the one apparatus-origin node.

10. The information processing apparatus according to claim 9, wherein
the self-position integration unit is configured to calculate the one final self-position as an information item of updating the apparatus origin position contained in the relative-position tree.

11. The information processing apparatus according to claim 5, wherein
the self-position integration unit is configured to calculate the one fused standard self-position by fusing the plurality of calculated standard self-positions by probability integration by Kalman filtering or by proportion integration.

12. The information processing apparatus according to 2, wherein
the self-position integration unit is configured to take the environment information into account by weighting or discarding one or more of the calculated standard self-positions in the calculation of the one final self-position.

13. The information processing apparatus according to claim 1, wherein
the self-position integration unit is configured to calculate a standard self-position by converting a calculated self-position into a standard self-position by use of link data that indicate the relative position of the self-position calculator with respect to an apparatus origin and/or of link data that indicate the relative position of the self-position calculator with respect to a self-position-calculator origin.

14. A movable apparatus, comprising:
an information processing apparatus as claimed in claim 1 for calculating one final self-position representing the position of the movable apparatus;
a planning unit configured to determine an action of the movable apparatus by utilizing the calculated one final self-position; and
an operation control unit configured to control an operation of the movable apparatus on the basis of the action that the planning unit has determined.

15. An information processing method comprising:
respectively calculating, by a plurality of self-position calculators, a plurality of self-positions, each self-position calculator using measurement information acquired by one or more sensors arranged in or at a movable apparatus to calculate its self-position representing the position of the respective self-position calculator; and
integrating, by a self-position integration unit, the plurality of calculated self-positions to one final self-position representing the position of the movable apparatus by calculating a plurality of standard self-positions by converting, in consideration of sensor positions of the one or more sensors, the plurality of calculated self-positions to the plurality of standard self-positions, a standard self-position representing the position of the movable apparatus determined by converting a calculated self-position, in consideration of the one or more sensor positions of the sensors utilized by the respective self-position calculator to calculate its self-position, to said standard self-position, and
calculating the one final self-position from the plurality of calculated standard self-positions.

16. A movable-apparatus control method comprising:
an information processing method as claimed in claim 17 for calculating one final self-position representing the position of the movable apparatus;
determining, by a planning unit, an action of the movable apparatus by utilizing the calculated one final self-position; and
controlling, by an operation control unit, an operation of the movable apparatus on the basis of the action that the planning unit has determined.

17. A program that causes a processor or computer to carry out the steps of the information processing method claimed in claim 15.

18. A non-transitory computer-readable recording medium that stores therein a computer program product, which, when executed by a processor or computer, causes the information processing method claimed in claim 15.
